(19) United States
(12) Patent Application Publication
(10) Pub. No.: US 2024/0046344 A1
(43) Pub. Date: Feb. 8, 2024

(54) Cloud-Based Media Content Management Platform

(71) Applicant: Hangzhou NetEase Cloud Music Technology Co., Ltd., Hangzhou (CN)

(72) Inventors: Dong Zhang, Beijing (CN); Nengxue Jiang, Beijing (CN); Ge Shao, Beijing (CN); Zongyang Han, Beijing (CN)

(73) Assignee: Hangzhou NetEase Cloud Music Technology Co., Ltd., Hangzhou (CN)

(21) Appl. No.: 17/972,874

(22) Filed: Oct. 25, 2022

(30) Foreign Application Priority Data
Aug. 8, 2022 (CN) 202210946456.1

(51) Int. Cl. G06Q 30/08

(52) U.S. Cl. CPC G06Q 30/08

(57) ABSTRACT

This applicant is directed to auction-related media content management. A server system executes a media play application on a media content management platform accessible to the plurality of user accounts. A first user interface is displayed in the media play application for a first user account, and includes an information item identifying a media content item and a user-selectable affordance item associated with the media content item. The server system receives, from the first user account, a user action on the user-selectable affordance item to initiate an auction of interest of the media content item owned by the first user account. In response to the user action, an auction request of the media content item is generated for the first user account. The server system receives a response to the auction request from a second user account, and associates the media content item with the second user account.

### RELATED APPLICATION

This application claims priority to a Chinese Patent Application No. 202210946456.1, titled “Business Processing Methods And Apparatuses, Storage Mediums And Electronic Devices,” filed Aug. 8, 2022, which incorporated by reference in its entirety.

### TECHNICAL FIELD

Embodiments of the present disclosure relate to the field of computer technology, and particularly, to methods, apparatuses, and non-transitory computer-readable storage media for facilitating auctioning of interests of media content items on a media content management platform.

### BACKGROUND

This section is intended to provide a background or context for embodiments of the present disclosure recited in the claims, and the description herein is not admitted to be prior art by inclusion in this section. With the rapid development of e-commerce and Internet technology, more and more offline business activities can be transferred online.

### SUMMARY

However, in some technologies, limited by characteristics of items themselves, business activities for some non-physical items (such as the copyright of multimedia data such as audio and video) cannot be carried out in the form of online activities, and cannot yet be held online completely with the advantages of Internet technology. Moreover, in the existing online auction system, the business logic is complex, leading to a large amount of computation during business processing, as a result, the computing resources of computers and servers are seriously wasted, and the service performance under the same hardware conditions is reduced. To this end, there is a great need for improved business processing methods and apparatuses, storage mediums, and electronic devices to provide an optimized and simplified business processing logic, reduce the resource consumption of computers, and be adapt to data processing solutions for online processing of multimedia items. In the present context, embodiments of the present disclosure are intended to provide business processing methods and apparatuses, storage mediums, and electronic devices.

In one aspect, a business processing method applied to a first type of user terminal is provided, and the method includes: establishing, in response to a to-be-processed multimedia item and business data configured for the to-be-processed multimedia item input by a user in a graphical user interface, an auction task corresponding to the to-be-processed multimedia item; and sending the auction task to the server to post the auction task by the server.

In another aspect, a business processing apparatus is provided, and the apparatus includes: an item configuring module, configured to establish, in response to a to-be-processed multimedia item and business data configured for the to-be-processed multimedia item input by a user in a graphical user interface, an auction task corresponding to the to-be-processed multimedia item; and an auction task pushing module, configured to send the auction task to the server to post the auction task by the server.

In yet another aspect, a storage medium is provided, and the storage medium has computer programs stored thereon that, when executed by a processor, cause the processor to implement the method of the first aspect.

In another aspect, an electronic device is provided, and the electronic device includes: a processor; and a memory for storing instructions executable by the processor; where the processor is configured to perform the method of the first aspect.

In another aspect, a business processing method applied to a second type of user terminal is provided, and the method includes: displaying, in response to a multimedia item selected by a user in a graphical user interface, a bidding parameter input interface; and generating, based on a current bidding parameter corresponding to the multimedia item input by the user in the bidding parameter input interface, a bidding task, and sending the bidding task to the server.

In another aspect, a business processing apparatus is provided, and the apparatus includes: a parameter input interface controlling module, configured to display, in response to a multimedia item selected by a user in a graphical user interface, a bidding parameter input interface; and a bidding task processing module, configured to generate, based on a current bidding parameter corresponding to the multimedia item input by the user in the bidding parameter input interface, a bidding task, and send the bidding task to the server.

In another aspect, a storage medium is provided, and the storage medium has computer programs stored thereon that, when executed by a processor, cause the processor to implement the method of the fifth aspect.

In another aspect, an electronic device is provided, and the electronic device includes: a processor; and a memory for storing instructions executable by the processor; where the processor is configured to perform the method of the fifth aspect.

In another aspect, a business processing method applied to a server is provided, and the method includes: receiving auction task information uploaded by a first user, wherein the auction task information includes item information and business data corresponding to a multimedia item; establishing, based on the auction task information, an auction task, and posting the auction task; receiving a bidding task uploaded by a second user, wherein the bidding task includes the item information and a current bidding parameter corresponding to the multimedia item; and generating, based on the bidding task, order status change information corresponding to the multimedia item, and sending the order status change information to the first user.

In another aspect, a business processing apparatus is provided, and the apparatus includes: an auction task information receiving module, configured to receive auction task information uploaded by a first user, wherein the auction task information includes item information and business data corresponding to a multimedia item; an auction task posting module, configured to establish, based on the auction task information, an auction task, and post the auction task; a bidding task receiving module, configured to receive a bidding task uploaded by a second user, wherein the bidding task includes the item information and a current bidding parameter corresponding to the multimedia item; and an order status change processing module, configured to generate, based on the bidding task, order status change information corresponding to the multimedia item, and send the order status change information to the first user.

In another aspect, a storage medium is provided, and the storage medium has computer programs stored thereon that, when executed by a processor, cause the processor to implement the method of the ninth aspect.

In another aspect, an electronic device is provided, and the electronic device includes: a processor; and a memory for storing instructions executable by the processor; where the processor is configured to perform the method of the ninth aspect.

In some implementations, a user can select a to-be-processed multimedia item to be posted in the interactive interface of the terminal device and configure corresponding business data, thereby an auction task corresponding to the multimedia item is established and the auction task is pushed to the server, so that the server can post the auction task of the multimedia item based on the business data to achieve online trade for the multimedia item. Thus, the business logic is effectively simplified, the overall business processing logic is optimized, and the consumption of computer resources is reduced.

### BRIEF DESCRIPTION OF THE DRAWINGS

The foregoing and other objects, features and advantages of exemplary embodiments of the present disclosure will be readily understood by reading the detailed description below with reference to the drawings. In the drawings, several embodiments of the present disclosure are illustrated in an exemplary, but not limiting, manner.

FIG. 1 schematically illustrates a schematic diagram of a business processing method applied to a first type of user terminal according to an embodiment of the present disclosure.

FIG. 2 schematically illustrates a schematic diagram of a business data input interface according to an embodiment of the present disclosure.

FIG. 3 schematically illustrates a schematic diagram of an auction task management interface according to an embodiment of the present disclosure.

FIG. 4 schematically illustrates a flowchart of a business processing method applied to a first type of user terminal according to an embodiment of the present disclosure.

FIG. 5 schematically illustrates a schematic diagram of a business processing method applied to a second type of user terminal according to an embodiment of the present disclosure.

FIG. 6 schematically illustrates a schematic diagram of an interface for displaying attribution information of a song according to an embodiment of the present disclosure.

FIG. 7 schematically illustrates a schematic diagram of displaying attribution information in a song playback interface according to an embodiment of the present disclosure.

FIG. 8 schematically illustrates a schematic diagram of displaying a list of multimedia items in an interface according to an embodiment of the present disclosure.

FIG. 9 schematically illustrates a flowchart of a business processing method applied to a second type of user terminal according to an embodiment of the present disclosure.

FIG. 10 schematically illustrates a schematic diagram of a business processing method applied to a server according to an embodiment of the present disclosure.

FIG. 11 schematically illustrates a schematic diagram of a system architecture according to an embodiment of the present disclosure.

FIG. 12 schematically illustrates a block diagram of a business processing apparatus applied to a first type of user terminal according to an embodiment of the present disclosure.

FIG. 13 schematically illustrates a block diagram of a business processing apparatus applied to a second type of user terminal according to an embodiment of the present disclosure.

FIG. 14 schematically illustrates a block diagram of a business processing apparatus applied to a server according to an embodiment of the present disclosure.

FIG. 15 schematically illustrates a diagram of a storage medium according to an embodiment of the present disclosure.

FIG. 16 schematically illustrates a block diagram of an electronic device according to an embodiment of the present disclosure.

FIG. 17 schematically illustrates a flowchart of a method for triggering a virtual resource authentication process according to an embodiment of the present disclosure.

FIG. 18 schematically illustrates a flowchart of a method for determining whether a bidding parameter satisfies a bidding rule, according to an embodiment of the present disclosure.

FIG. 19 is an example media content management environment having one or more servers communicatively coupled to one or more media devices, in accordance with some embodiments.

FIG. 20 is a block diagram illustrating a server, in accordance with some embodiments.

In the accompanying drawings, identical or corresponding reference numerals indicate identical or corresponding parts.

### DETAILED DESCRIPTION OF THE EMBODIMENTS

The principles and spirit of the present disclosure will be described below with reference to a number of exemplary embodiments. It should be understood that these embodiments are given solely to enable those skilled in the art to better understand and thus implement the present disclosure, and are not intended to limit the scope of the present disclosure in any way. Rather, these embodiments are provided to make the present disclosure more clearly and complete, and to enable the complete scope of the present disclosure to be communicated to those skilled in the art.

Those skilled in the art will understand that embodiments of the present disclosure can be implemented as a system, apparatus, device, method, or computer program product. Accordingly, the present disclosure may be specifically implemented in the form of: full hardware, full software (including firmware, resident software, microcode, etc.), or a combination of hardware and software.

According to embodiments of the present disclosure, business processing methods, business processing apparatuses, storage mediums, and electronic devices are provided.

Herein, any number of elements in the drawings are used for example and not limitation, and any naming is used for distinction only and does not have any limiting meaning.

The principles and spirit of the present disclosure are described in detail below with reference to several representative embodiments of the present disclosure.

### Invention Overview

The inventors have found that in the related art, for multimedia items, such as songs, videos, etc., the existing solutions for online auction on physical items are not fully applicable to the scenario of auction on multimedia items due to the substantial distinction between the data itself and the physical items. Moreover, the business logic of existing auction systems or applications is complex, which brings a huge waste of resources to computers.

In view of the above, the basic idea of the present disclosure is that the business processing methods and the business processing apparatuses according to embodiments of the present disclosure can be applied to the auction on multimedia items and the subsequent distribution of profits. Based on Internet technology, the online trade of multimedia items is achieved. Moreover, the business logic is effectively simplified, the overall business processing logic is optimized, and the consumption of computer resources is reduced.

The basic principle of the present disclosure has been introduced; various non-limiting embodiments of the present disclosure are described specifically below.

### Exemplary Methods

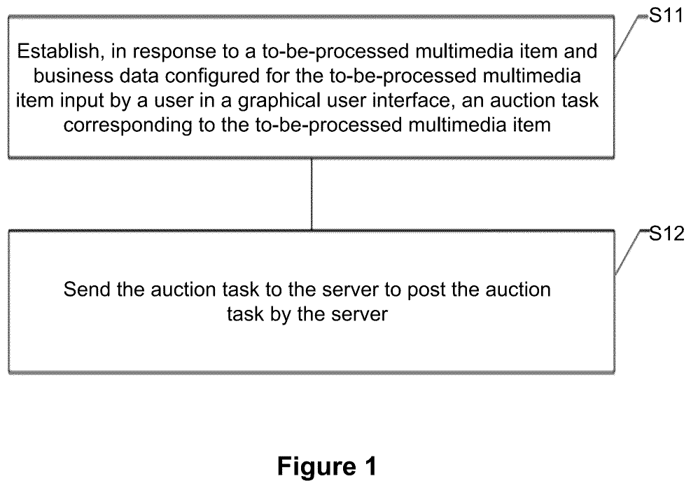

A business processing method according to an exemplary embodiment of the present disclosure, applied to a user terminal of a first type of user, is described below in connection with FIG. 1. Where the first type of user may be a musician user. Referring to FIG. 1, the business processing method may include the following steps.

At step S11, in response to a to-be-processed multimedia item and business data configured for the to-be-processed multimedia item input by a user in a graphical user interface, an auction task corresponding to the to-be-processed multimedia item is established.

At step S12, the auction task is sent to the server to post the auction task by the server.

In the business processing method of embodiments of the present disclosure, the user can select the to-be-processed multimedia item to be posted in the interactive interface of the terminal device and configure the corresponding business data, thereby an auction task corresponding to the multimedia item is established and the auction task is pushed to the server, so that the server can post the auction task of the multimedia item based on the business data to achieve online trade for the multimedia item. Moreover, the business logic is effectively simplified, the overall business processing logic is optimized, and the consumption of computer resources is reduced.

In step S11, in response to the to-be-processed multimedia item and business data configured for the to-be-processed multimedia item input by the user in the graphical user interface, the auction task corresponding to the to-be-processed multimedia item is established.

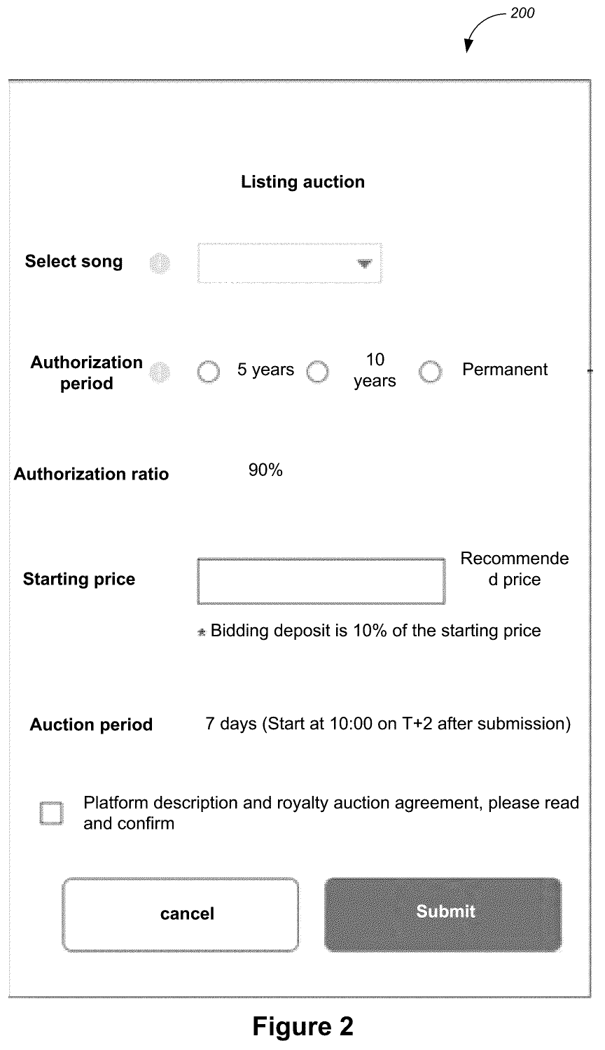

In an exemplary embodiment of the present disclosure, the multimedia items may be multimedia data of the type of music, video, etc. Referring to the interactive interface shown in FIG. 2, the user can select a song to be submitted for auction as the to-be-processed multimedia item in the interactive interface. Moreover, the business data corresponding to the multimedia item can also be configured. After inputting the customized business data in the interactive interface, the user can click a “submit” button, and then an auction task is established for the song based on the business data and the selected song.

In an exemplary embodiment of the present disclosure, the business data configured for the to-be-processed multimedia item includes: an authorization period parameter, an authorization ratio parameter, an initial price parameter, etc.

Illustratively, with reference to FIG. 2, the above-mentioned authorization period parameter may be an authorization period, such as 5 years, 10 years, or perpetuity, etc. The above-mentioned authorization ratio parameter may be an authorized percentage, such as 90%, 100%, 65%, and so on. The above initial price parameter may be a user-defined value, such as 2000, 1, 3999.99, and so on.

In some exemplary embodiments of the present disclosure, the user-defined business data may also include an auction period, an auction date, and so on. The specific value of each of the above business data may also be other specific value, which may be configured according to actual needs.

In an exemplary embodiment of the present disclosure, the auction task corresponding to the song is a song royalty revenue auction task, and for a digital song, the revenue of a song=a total revenue of digital single song sales×(1−a channel cost ratio)×a royalty ratio (a copyright owner's share ratio)×a percentage of the copyright of the song owned by an auction task party.

In step S12, the auction task is sent to the server to post the auction task by the server.

In an exemplary embodiment of the present disclosure, after the auction task is established on the terminal device, the auction task data can then be uploaded to the server to process the task data corresponding to the auction task by the server.

In an exemplary embodiment of the present disclosure, the above method may further include: collecting playback history data corresponding to the to-be-processed multimedia item; and evaluating the initial price of the to-be-processed multimedia item based on the playback history data, and pushing the initial price evaluation result to the user.

Specifically, the user clicks a “proposed price” button in the interactive interface of FIG. 2, and the terminal device can respond to the touch operation to trigger the initial price evaluation process and invoke the price evaluation service. Specifically, the terminal device can request a statistical result of the playback history data corresponding to the song from the server. Wherein, the statistical result may include the number of playbacks of the song, the frequency of playbacks of the song, the number of comments of the song, the number of reposts of the song and the number of recreated works, and other relevant statistics. After receiving the statistical result of the song playback history data, the terminal device evaluates the initial price evaluation result of the song according to the predetermined calculation strategy, and displays the initial price evaluation result in the interactive interface. For example, the calculation strategy may configure different weighting coefficients for each statistical result item, match a basic value based on the total number of playbacks of the song, and then combine the statistical results of each statistical result item to generate the final initial price evaluation result. Alternatively, the calculation strategy may perform calculating with configured business data, e.g., combining the authorization period, the number of playbacks, the authorization ratio, and random parameter in a multiplicative operation.

In an exemplary embodiment of the present disclosure, the method described above may further include: displaying a list of auction tasks in the graphical user interface, where the list of auction tasks includes a plurality of categories of tasks according to task execution status; and displaying, in response to a selection operation for an auction task in the auction task list, task information for the auction task.

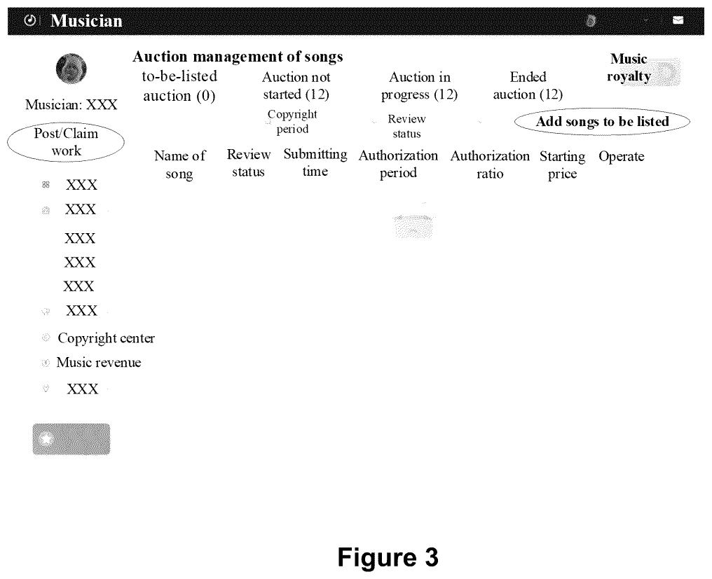

Specifically, with reference to FIG. 3, an auction task management list may be provided in the interactive interface; tasks may be displayed in categories based on the status of the auction task. For example, the types of classification may include: ended auctions, auctions in progress, auctions not started, and to-be-listed auctions. Where to-be-listed auctions may include tasks that are waiting for review by the server and tasks that have not passed the review; auctions not started may include tasks that have passed the task review but have not yet reached the auction start time; auctions in progress may include tasks that have started the auction process and have not yet reached the end of the auction cycle.

More specifically, in the interactive interface shown in FIG. 3, when the user clicks to select a category, specific information about the category can be displayed. For example, basic song information, a song cover, and a song name, and after clicking on a cover or name of a song, it is also possible to jump to the home page of the song to display more information about the song. In addition, and specific business information of the song can be displayed, such as, a submission time (listing submission time), an authorization period, a starting price, an auction start time (10:00 on submission date T+2), calculated auction end time (the submission date+the auction period, e.g., 7 days by default), status information, etc. In addition, the user can also perform operations on songs, such as: cancelling list (only for songs in to-be-auctioned status), re-listing. In addition, for songs in auction, the user can also perform control operations to view the bidding, for example, the user can click on the song to display a leading price, an out price, a bidding time, a user avatar and other information in a new interactive interface or a pop-up window. For ended auction tasks, different status result information can also be displayed in the interactive interface, such as pending payment, paid, unsold, payment failure, etc. In addition, the user can also view the revenue information. For tasks displayed with unsold or payment failure, a re-list button can also be configured.

In an exemplary embodiment of the present disclosure, the above method may further include: receiving a review result of the auction task from the server; and labeling the auction task according to the review result.

Specifically, on the terminal device, after uploading an auction task to the server, the review result of the auction task by the server may also be received.

Illustratively, referring to FIG. 3, in the auction task management list provided in the interactive interface, to-be-listed tasks may be labeled with a review result. For example, the types of labels can include: pending review, timeout not reviewed, and failure to pass the review. For example, after receiving a result for review not approved from the server for a to-be-listed song, the task can be labeled according to the review result. In addition, for a to-be-listed song failing to pass the review, the user can also view the corresponding review failure information, including the reason, etc.

In an exemplary embodiment of the present disclosure, the above method may further include: receiving, during an execution cycle of the auction task, order status change information corresponding to the auction task.

Specifically, for an auction task in the auction cycle, when order information, such as new bidding price, paid, or unsold, appears, the server can then send the order status change information to the corresponding terminal, and the terminal device can receive the order status change information sent by the server and display the order status change information in the interactive interface.

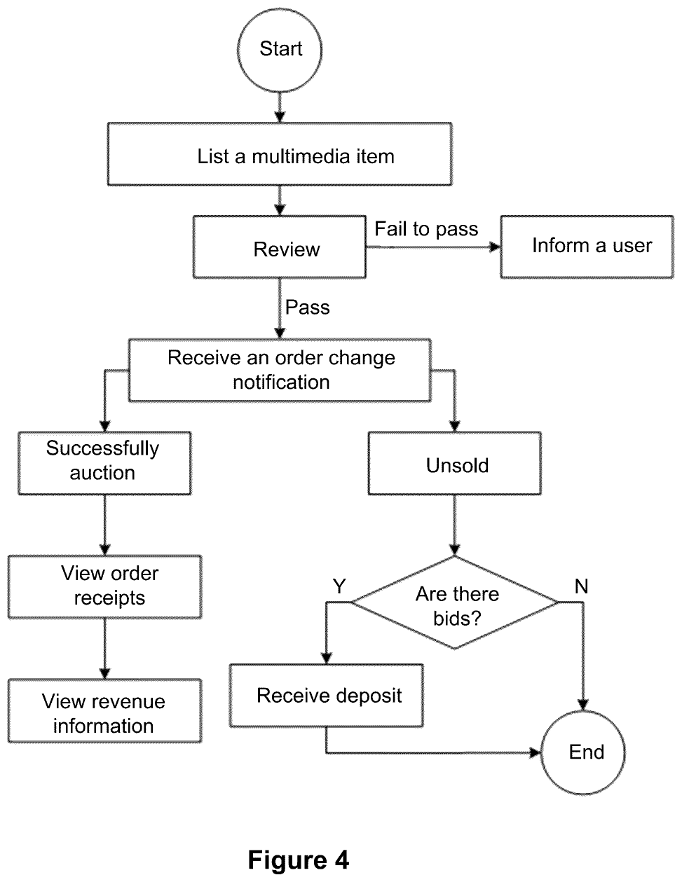

In an exemplary embodiment of the present disclosure, with reference to FIG. 4, for a musician user terminal, after a multimedia item is listed, the multimedia item enters the review process of the server. If the multimedia item fails to pass the review, the user is informed and the corresponding task is labeled. If the multimedia item passes the review, the multimedia item is posted, and the musician user terminal starts receiving an order change notification. When successfully auctioning, the user can view the order receipt information, as well as subsequently receive the revenue information from the server. If the multimedia item is unsold, the server will take corresponding action according to whether there is bidding information. If there is the bidding information, the deposit corresponding to the biding user is received, and the process is ended; if no user bids, the process is ended.

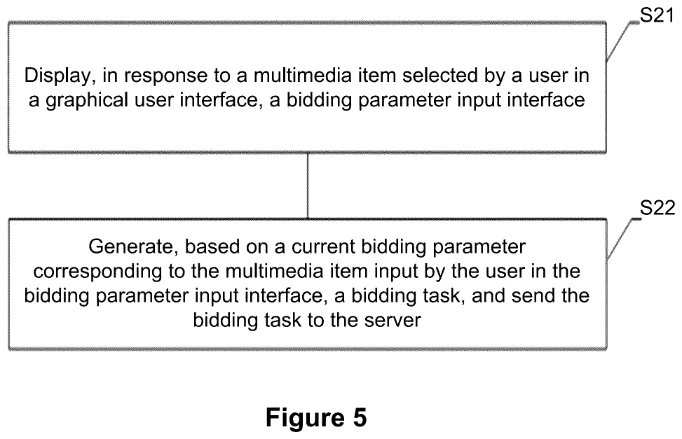

Another business processing method, applied to a user terminal of a second type of user, according to exemplary embodiments of the present disclosure is described below in connection with FIG. 5. Herein, the second type of user may be a participating bidding user. Referring to FIG. 5, the business processing method may include the following steps.

At step S21, in response to a multimedia item selected by a user in a graphical user interface, a bidding parameter input interface is displayed.

At step S22, based on a current bidding parameter corresponding to the multimedia item input by the user in the bidding parameter input interface, a bidding task is generated, and the bidding task is sent to the server to post the bidding task.

In step S21, in response to a multimedia item selected by a user in a graphical user interface, a bidding parameter input interface is displayed.

In an exemplary embodiment of the present disclosure, an ordinary user is as a participating bidding user, the multimedia item may be displayed in the interactive interface and the multimedia item may be differently displayed according to the task type of the multimedia item, for example, the multimedia item may be displayed in the interactive interface according to the types of auctions in progress, auctions not started, and ended auctions, respectively.

In the interactive interface, the user can select and search for a multimedia item in the auction cycle, such as a song, and the details corresponding to the song are displayed. More specifically, in the interactive interface, for a song that does not start bidding, a song cover, a song name, artist information, a label, countdown to start, and starting price can be displayed. For a song in the auction, bidding record information that can also be displayed, includes an avatar and a nickname of the bidding user, bidding time, the bidding value, and other information.

For songs in the auction, after the user clicks to select a song, the bidding parameter input interface is displayed. The interface can be in the form of a pop-up window. The user can input the specific value of bidding.

In an exemplary embodiment of the present disclosure, the above method may further include: triggering an authentication process for identity information of the user when the user inputs the current bidding parameter corresponding to the multimedia item in the bidding parameter input interface.

Specifically, the terminal device may query the user's authentication information locally, and if the user's authentication information is not queried locally, the user's authentication status may be queried from the server and synchronized locally to the terminal. If the current user has completed authentication, the user is allowed to input a value in the interface; or, if the current user has not completed authentication, an authentication prompt message is displayed to allow the user to input the authentication information.

In step S22, based on a current bidding parameter corresponding to the multimedia item input by the user in the bidding parameter input interface, a bidding task is generated, and the bidding task is sent to the server.

In exemplary embodiments of the present disclosure, with reference to FIG. 17, the above method may further include the following steps.

At step S2211, a virtual resource authentication process for the user is triggered after the user inputs the current bidding parameter corresponding to the multimedia item.

At step S2212, after determining that the user has completed the virtual resource authentication process, the bidding task is generated based on the current bidding parameter.

Specifically, the virtual resource authentication process may be an identification task of whether the user's deposit is paid or not. For example, after the user inputs the current bidding parameter, the virtual resource authentication process is triggered for the user, specifically, a resource authentication service is invoked to query the user's virtual resource account to determine whether a deposit has been completed. After determining that the user has completed the virtual resource authentication process, the bidding task is generated based on the current bidding parameter. If the user has not paid the deposit, a corresponding error prompt message is displayed and a deposit payment window is displayed.

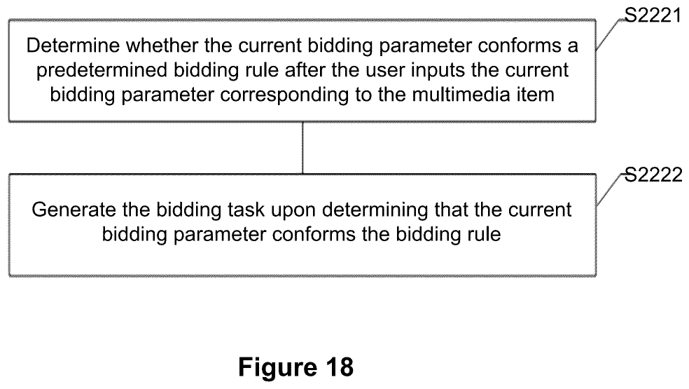

In an exemplary embodiment of the present disclosure, with reference to FIG. 18, the above method may further include the following steps.

At step S2221, whether the current bidding parameter conforms a predetermined bidding rule is determined after the user inputs the current bidding parameter corresponding to the multimedia item.

At step S2222, the bidding task is generated upon determining that the current bidding parameter conforms the bidding rule.

Specifically, after identifying that the user has completed the virtual resource authentication process, when the user bids, it is also possible to determine whether the current bidding parameter satisfies the predetermined bidding rule by a predetermined judgment rule based on the value of the deposit paid by the user. For example, the predetermined bidding rule may be to determine whether the value of the paid deposit is >=10% of the target bidding. If 10% of the current bidding is less than or equal to the value of the deposit, a confirmation pop-up window is displayed and the bidding task is generated after the user confirms. If 10% of the current bidding is greater than the value of the deposit, the virtual resource authentication process is triggered and the deposit payment page is displayed, and the song detail page can be returned to continue the bidding process after the deposit is paid. The terminal device generates a bidding task based on the current input value of the user and sends the bidding task to the server.

In another exemplary embodiment of the present disclosure, if the user pays the value of the deposit exceeding a certain threshold, the user may bid without a limit, i.e., there is no need to determine whether the value of the paid deposit is >=10% of the target bid.

In addition, a bidding task table can be established locally in the terminal device to store relevant parameters of the bidding task, such as an execution time of the bidding task, a song identification, a user identification, a value of the bidding, etc., to facilitate a subsequent data verification.

In an exemplary embodiment of the present disclosure, the above method may further include: receiving a bidding task feedback message corresponding to the bidding task, where the bidding task feedback message indicates the bid is successful or unsuccessful.

Specifically, the server may determine which user has an earlier bidding task with a larger value based on the time and value of the bidding tasks, thereby making a judgment about the validity of the bidding, and outputting the judgment result, and providing the judgment result of the bidding back to the user. Where the successful bid can be that the value of the bidding is the current maximum; the unsuccessful bid can be that the value of the bidding is less than the current existing maximum, or, when there are bidding tasks with the same value, the unsuccessful bid is caused by the late quotation time.

Illustratively, the rules for the user's bidding interaction upon bidding can be as shown in the contents of Table 1. Where the first bidding refers to a first bidding when no bidding is recorded for that lot.

TABLE 1
Rules for Bidding Interaction

| Serial No. | Scenario | Interaction |
|---|---|---|
| 1 | A first bid is successful. | Preceding status: a value displayed on the bidding |
| | | device is a starting price. |
| | | Bidding operation: no limit to the number of |
| | | bidding increment, and after clicking the |
| | | bidding button, pop-up a window to |
| | | confirm. |
| | | Ending status: toast-“successful bidding”; bidding |
| | | button-“leading”, grayed out; a value |
| | | displayed on the bidding device is changed |
| | | to a sum of the current bidding price and |
| | | one bidding increment; bidding record - |
| | | refresh. |
| 2 | A first bid is | Preceding status: a value displayed on the bidding |
| | unsuccessful. (Other | device is a starting price. |
| | bidders preempt.) | Bidding operation: no limit to the number of |
| | | bidding increment, and after clicking the |
| | | bid button, pop-up a window to confirm. |
| | | Ending status: toast - “your bidding price is lower |
| | | than the current bidding price, please re- |
| | | bidding”; bidding button - “proceed to |
| | | bidding”; a value displayed on the bidding |
| | | device is changed to a sum of the current |
| | | bidding price and one bidding increment; |
| | | bidding record - refresh. |
| 3 | A non-first bid is | Preceding status: a value displayed on the bidding |
| | successful. | device is a sum of the current bidding |
| | | price and one bidding increment. |
| | | Bidding operation: no limit to the number of |
| | | bidding increment, and after clicking the |
| | | bid button, pop-up a window to confirm. |
| | | Ending status: toast - “successful bid”; bidding |
| | | button - “leading”, grayed out; a value |
| | | displayed on the bidding device is changed |
| | | to the current bidding price and one |
| | | bidding increment; bidding record - |
| | | refresh. |
| 4 | A non-first bid is | Preceding status: a value displayed on the bidding |
| | unsuccessful. (Other | device is a sum of the current bidding |
| | bidders preempt.) | price and one bidding increment. |
| | | Bidding operation: no limit to the number of |
| | | bidding increment, and after clicking the |
| | | bid button, pop-up a window to confirm. |
| | | Ending status: toast - “your bidding price is lower |
| | | than the current bidding price, please re- |
| | | bidding”; bidding button - “proceed to |
| | | bidding”; a value displayed on the bidding |
| | | device is changed to the current bidding |
| | | price and one bidding increment; bidding |
| | | record - refresh. |
| 5 | A bid is unsuccessful, | Preceding status: a value displayed on the bidding |
| | the bidding price is | device is lower than the current bidding |
| | lower than the current | price. |
| | bidding price. | Bidding operation: no limit to the number of |
| | | bidding increment, and after clicking the |
| | | bid button, pop-up a window to confirm. |
| | | Ending status: toast - “your bidding price is lower |
| | | than the current bidding price, please re- |
| | | bidding”; bidding button - “proceed to |
| | | bidding”; a value displayed on the bidding |
| | | device is unchanged; bidding record - not |
| | | refresh. |
| 6 | A bid is exceeded, the | Preceding status: a value displayed on the bidding |
| | value displayed on the | device is lower than a sum of the current |
| | bidding device is less | bidding price and one biding increment. |
| | than a sum of the current | Ending status: bidding button - “proceed to |
| | bidding price and one | bidding”; a value displayed on the bidding |
| | bidding increment. | device is changed to a sum of the current |
| | | bidding price and one bidding increment; |
| | | bidding record - refresh. |
| 7 | A bid is exceeded, the | Preceding status: a value displayed on the bidding |
| | value displayed on the | device is not lower than a sum of the |
| | bidding device is not | current bidding price and one bidding |
| | less than a sum of the | increment. |
| | current bidding price | Ending status: bidding button - “proceed to |
| | and one bidding | bidding”; a value displayed on the bidding |
| | increment. | device is unchanged, the bidding price is |
| | | adjustable; bidding record - refresh. |
| 8 | Other interaction | Click logic for the minus sign of the bidding |
| | additions | device: |
| | | for a first bid: the minus sign cannot be |
| | | clicked when the displayed price is equal |
| | | to the starting price. |
| | | for non-first bid: the minus sign cannot be |
| | | clicked when the displayed price is less |
| | | than or equal to a sum of the current |
| | | bidding price and one bidding increment. |

In an exemplary embodiment of the present disclosure, the above method may further include: receiving task status change information corresponding to the multimedia item; and triggering a user virtual resource processing task process corresponding to the multimedia item.

Specifically, after a user has successfully bid on a multimedia item, the user may receive the task status change information from the server for the successful bid, and the user virtual resource processing task process corresponding to the multimedia item is triggered to make the payment. The user virtual resource processing task process can be executed in a separate interface in which song information, song entitlement (authorization period, authorization entitlement, i.e., the value of the bidding), and a mode of payment are displayed.

In an exemplary embodiment of the present disclosure, the above method may further include: configuring multimedia data attribution information corresponding to the multimedia item according to user information of the user.

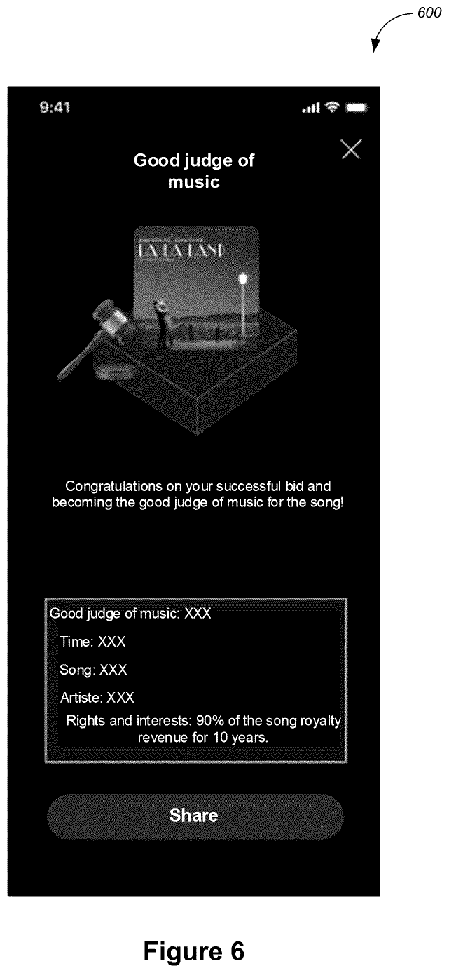

Specifically, for a song that is successfully bid by a user, the attribution information may be configured for the song, and the attribution information may be displayed in the details of the song. For example, referring to the interface shown in FIG. 6, where the details page of the successfully auctioned song is displayed. The interface shown in FIG. 6 can display a name of the song, a cover image of the song, artist information, time of the auction, entitlement information, a nickname and ID of a person who bids the song successfully (good judge of music). Also, in the interface, a sharing link for the details page of the successfully auctioned song is configured, when the “sharing” button is clicked in the interface, a page sharing service can be invoked to share the details page to other applications.

In an exemplary embodiment of the present disclosure, the above method may further include: determining a mode of display for the multimedia data attribution information corresponding to the multimedia item based on display configuration information for the multimedia data attribution information of the user.

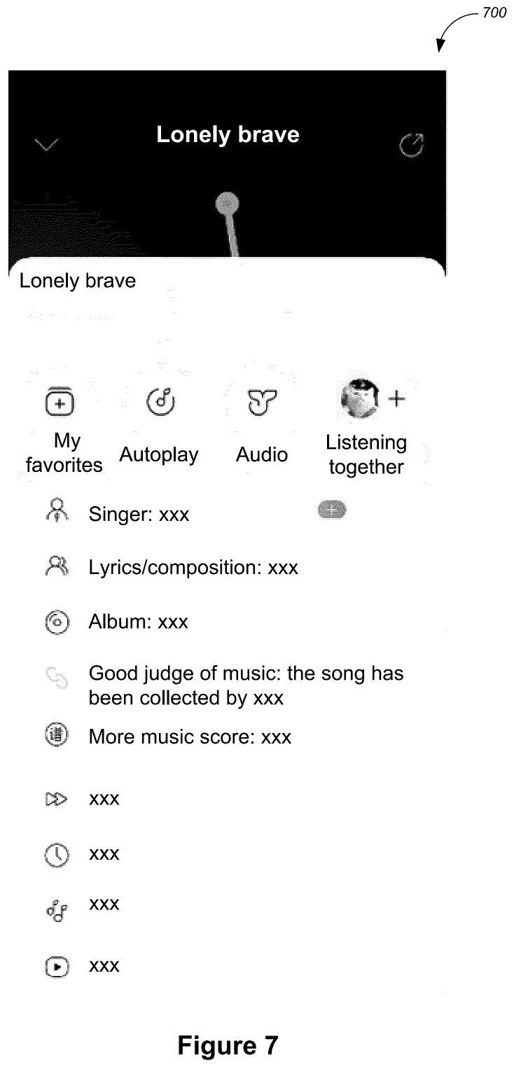

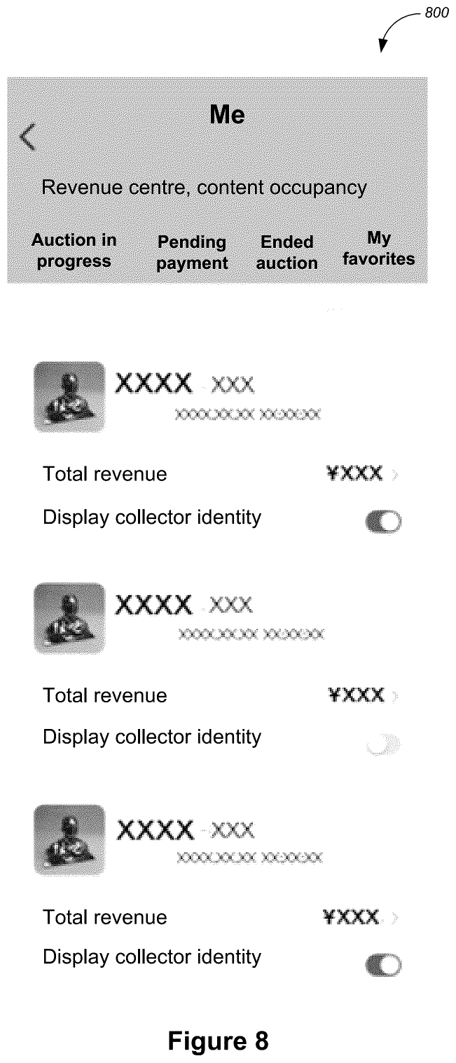

Specifically, the user may configure the display of the music attribution information. For example, in the interface shown in FIG. 8, a “showing collector identity” control is used to select whether to display the attribution information. For example, if the user chooses to display the attribution information, referring to the details page shown in FIG. 7, the owner's identity is displayed in information for the “good judge of music”. Alternatively, the user may choose to not display the user information, the user can hide the owner's identity in the information for the “good judge of music”, or the information for the “good judge of music” is hidden. In this case, the “good judge of music” is the successful bidder for the song.

In an exemplary embodiment of the present disclosure, the above method may further include: displaying a list of multimedia items in the graphical user interface, where the list of multimedia items includes a plurality of categories based on the status of the multimedia items; and displaying, in response to a selection operation of the multimedia items of the target category in the list of multimedia items, revenue information corresponding to the multimedia items based on received revenue data.

Specifically, with reference to FIG. 8, the categories of multimedia items can be divided according to auction in progress, pending payment, ended auction, and my favorites. A song can be selected in the category of “my favorites” in the interface to display the corresponding revenue information. The specific information of royalty revenue, for example, including total historical revenue, yesterday's estimated revenue, last month's estimated revenue, etc., can be displayed in the next level window.

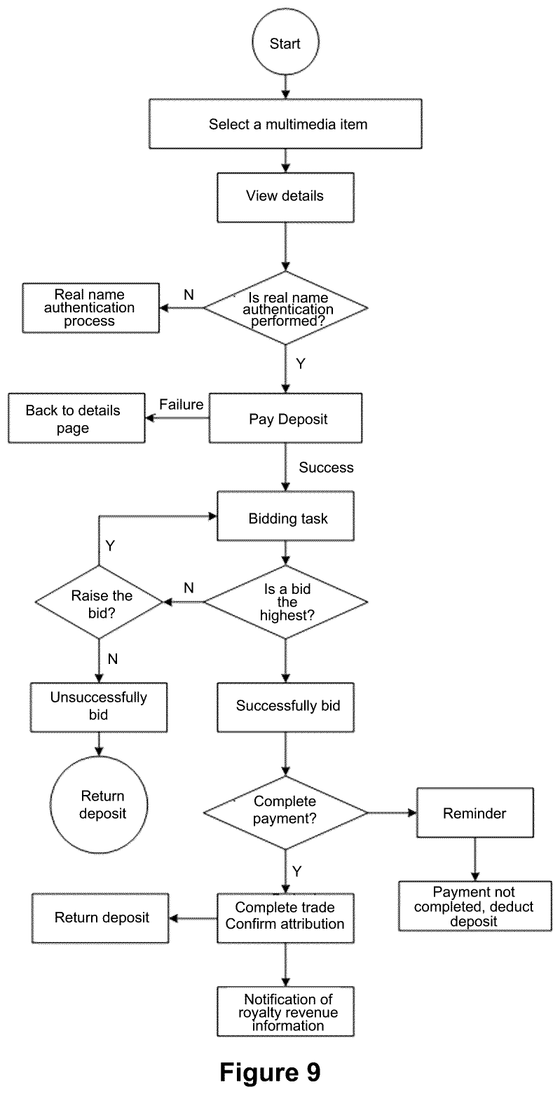

In an exemplary embodiment of the present disclosure, with reference to FIG. 9, for a user terminal, after selecting a multimedia item to be bid on the interactive interface, detailed information for the song, for example, including information for the song and information for the current auction process, can be viewed. When bidding, the identity authentication process and deposit confirmation process for the user can be triggered first. After the user completes the identity authentication and deposit payment, the bidding task is generated and uploaded to the server based on the bidding of the user at the terminal. During the auction process, if the bidding price of the user is not the highest, the bidding task can be retriggered, if the user does not raise the bid again, at the end of the auction, the bid is unsuccessful and a task of returning the deposit to the user is triggered. Alternatively, at the end of the auction, if the bidding price of the current user is the highest, the bid is successful, after the user completing payment, the confirmation of rights is completed, and the user can configure the mode of display for the attribution information and receive the royalty revenue information at the terminal; or, if the user does not complete payment within the specified time, a reminder task is triggered. If the payment is not completed within the specified time, a deposit deduction task is triggered to deduct the deposit of the user.

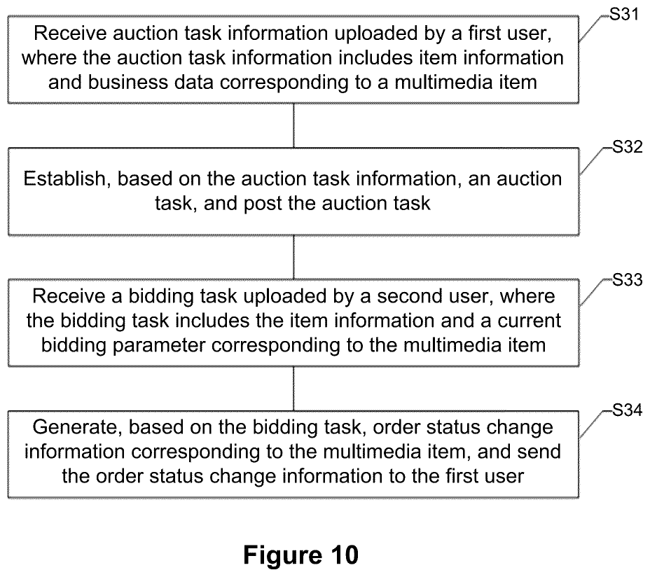

Another business processing method according to an exemplary embodiment of the present disclosure, applied to a server, is described below in connection with FIG. 10.

At step S31, auction task information uploaded by a first user is received, where the auction task information includes item information and business data corresponding to a multimedia item.

At step S32, based on the auction task information, an auction task is established, and the auction task is posted.

At step S33, a bidding task uploaded by a second user is received, where the bidding task includes the item information and a current bidding parameter corresponding to the multimedia item.

At step S34, based on the bidding task, order status change information corresponding to the multimedia item is generated, and the order status change information is sent to the first user.

In an exemplary embodiment of the present disclosure, the above method further includes: triggering a task review process based on the auction task information to obtain a task review result before establishing the auction task based on the auction task information; and triggering the auction task establishing process when the task review result indicates a pass.

Specifically, for the server, the auction task information uploaded by a musician user at a terminal device is received and a review task for that multimedia item (such as a song) is established. For example, the lyric and composing of the song can be identified and evaluation tasks can be established, respectively, and the data can be compared by using the existing sample database to output the evaluation result of whether there is a copyright risk, and the task review result can be generated based on the evaluation result. If the evaluation result of any one or more of the lyric or composing of the song does not meet preset conditions, the review result indicates a failure.

The server posts the task when the review result of the song indicates a pass, and feeds back a message to the first user terminal that the task has been posted. Alternatively, if the review result indicates a failure, the server feeds back a message with a review opinion to the first user terminal that the review result indicates a failure.

In an exemplary embodiment of the present disclosure, during the execution cycle of the auction, the bids for a song may be received from each of the second users, and the order status change information is fed back to the first user based on the bids. Where the order status change information may include biding information, payment information, unsold item information, and the like.

In an exemplary embodiment of the present disclosure, the method further includes: upon reaching a predetermined execution cycle corresponding to the auction task, determining a task status change information corresponding to the multimedia item based on the bidding task corresponding to the earliest time and highest value and sending task status change information to the first user and the second user.

Specifically, at the end of the auction cycle, a successful bidding user may be confirmed based on the last bidding task with a successful bid. For example, the successful bidding user may be confirmed based on a bidding task with the highest bidding price; or, if there are multiple bidding tasks with the same highest value, based on the time of the bidding tasks, the bidding task with the earliest time is selected as a bidding task with a successful bid, the successful bidding user is confirmed, a confirmation message is generated and is determined as the task status change message, and the task status change message is sent to the first user and the second user. In addition, the user virtual resource processing task process corresponding to the current multimedia item can also be triggered by the server for the second user.

In an exemplary embodiment of the present disclosure, the method further includes: configuring multimedia data attribution information corresponding to a multimedia item based on the user information of the second user.

Specifically, after identifying the second user to complete the user virtual resource processing task process, the attribution information for the song can be configured based on the user information for the second user and the song information for the song can be modified in the database.

In an exemplary embodiment of the present disclosure, the method further includes: determining a mode of display for the multimedia data attribution information corresponding to the multimedia item based on display configuration information for the multimedia data attribution information by the second user.

Specifically, the second user, after selecting the mode of display of the attribution information of the song at the terminal device, sends a notification message to the server, and the server modifies the display result of the attribution information of the song according to the notification message.

In an exemplary embodiment of the present disclosure, the business data configured for the multimedia item includes: an authorization period parameter, an authorization ratio parameter, and an initial price parameter.

In an exemplary embodiment of the present disclosure, the method further includes the following steps.

At step S41, item asset revenue information corresponding to the multimedia item is aggregated according to a predetermined statistical cycle.

At step S42, first user revenue information corresponding to the first user and second user revenue information corresponding to the second user is determined in combination with the authorization ratio parameter and the item asset revenue information.

At step S43, the first user revenue information is sent to the first user, and the second user revenue information is sent to the second user.

Specifically, for the server, a timing task can be set for the successfully auctioned song to calculate the royalty revenue of the song according to the preset statistical cycle, and to calculate the royalty revenue data of the corresponding musician and the attribution user according to the authorization ratio of the song, and to push the revenue information to the terminal devices, respectively.

In some exemplary embodiments of the present disclosure, for the server, historical playback data and interaction data of unlisted multimedia data can be aggregated to determine the multimedia data that can be auctioned according to the preset criterion, and send an auction recommendation message to the copyright owners of these multimedia data.

Furthermore, in some exemplary embodiments of the present disclosure, for the server, auction recommendation message of a target multimedia data can be received from the second user, and the auction recommendation message is sent to the first user corresponding to the target multimedia data. The first user, after receiving the auction recommendation message, may choose to list the corresponding song and participate in the auction.

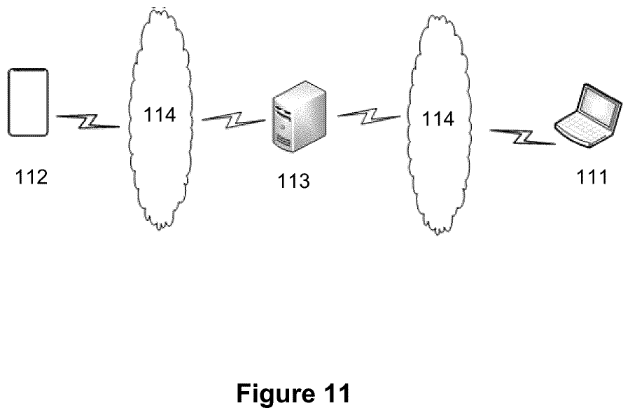

The business processing methods provided in the present disclosure can be applied in a system architecture as shown in FIG. 11, which can include a first terminal device (e.g., a computer 111 shown in FIG. 11), a second terminal device (e.g., a cell phone 112 shown in FIG. 11), a network 114, and a server 113. The network 114 is used to provide a medium for a communication link between the terminal device and the server 113. The network 114 may include various types of connections, such as a wired communication link, a wireless communication link, and the like. It should be understood that the number of terminal devices, networks, and servers in FIG. 11 is only schematic. There may be any number of terminal devices, networks, and servers as required by the embodiment. For example, the server 113 may be a server cluster of multiple servers, etc. Where the first terminal device may be a musician terminal device and the second terminal device may be a bidding user terminal device.

In summary, the present disclosure provides business processing methods in which, through the system architecture described above, the first user, i.e., a musician user, can submit multimedia data, such as music or video, as a multimedia item to the server for an auction task, and the first user can customize the business data such as an authorization ratio and an authorization period. For the server, after receiving the auction task uploaded by the first user, the multimedia item can be reviewed and the auction task is posted after the multimedia item passing the review. The second user, i.e., the bidding user, can select the specified multimedia item to participate in the auction after completing the authentication and deposit payment procedures. After the song is successfully auctioned, attribution information and a mode of displaying the attribution information corresponding to the song can be configured by the server or the second terminal. In addition, after the song is successfully auctioned, the royalty revenue information of the song can be pushed to the first user and the second user according to the preset cycle. Thus, online auction of a non-physical multimedia item is achieved, such that the recipient of the music royalty revenue is converted from a musician to a non-musician user. Moreover, the first user can customize the business data to achieve the authorization listing, online trade, revenue share settlement process, and online interchange operation process for the music royalty revenue. Thus, the business logic of the online auction system is effectively simplified, the business logic is partially shared by the terminal, the computational pressure on the server is greatly reduced, and the resource usage of the server is reduced.

### Exemplary Apparatus

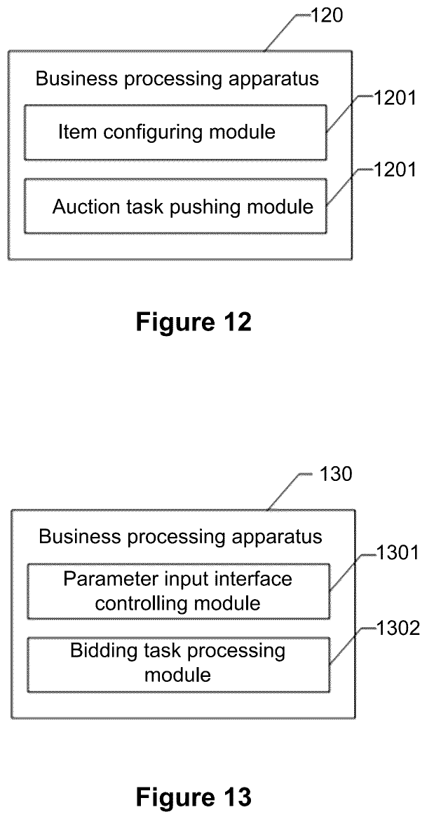

After the business processing methods of exemplary embodiments of the present disclosure has been described, the business processing apparatus applied to the first type of user terminal device of an exemplary embodiment of the present disclosure may be described with reference to FIG. 12.

Referring to FIG. 12, the business processing apparatus 120 of an exemplary embodiment of the present disclosure may include: an item configuring module 1201 and an auction task pushing module 1202.

The item configuring module 1201 can be configured to establish, in response to a to-be-processed multimedia item and business data configured for the to-be-processed multimedia item input by a user in a graphical user interface, an auction task corresponding to the to-be-processed multimedia item.

The auction task pushing module 1202 can be configured to send the auction task to the server to post the auction task by the server.

According to an exemplary embodiment of the present disclosure, the apparatus 120 further includes a task labeling module.

The task labeling module can be configured to receive, after sending the auction task to the server, a review result of the auction task by the server; and label the auction task according to the review result.

According to an exemplary embodiment of the present disclosure, the apparatus 120 further includes an order information receiving module.

The order information receiving module can be configured to receive, during an execution cycle of the auction task, order status change information corresponding to the auction task.

According to an exemplary embodiment of the present disclosure, the business data configured for the to-be-processed multimedia item includes an authorization period parameter, an authorization ratio parameter, and an initial price parameter.

According to an exemplary embodiment of the present disclosure, the apparatus 120 further includes a price evaluating module.

The price evaluating module can be configured to collect playback history data corresponding to the to-be-processed multimedia item; and evaluate the initial price of the to-be-processed multimedia item based on the playback history data, and push the initial price evaluation result to the user.

According to an exemplary embodiment of the present disclosure, the apparatus 120 further includes a task information display controlling module.

The task information display controlling module can be configured to display a list of auction tasks in the graphical user interface, where the list of auction tasks includes a plurality of categories of tasks according to task execution status; display, in response to a selection operation for an auction task in the auction task list, task information for the auction task.

Referring to FIG. 13, a business processing apparatus applied to a second type of user terminal device of an exemplary embodiment of the present disclosure is described.

Referring to FIG. 13, the business processing apparatus 130 of an exemplary embodiment of the present disclosure may include a parameter input interface controlling module 1301 and a bidding task processing module 1302.

The parameter input interface controlling module 1301 can be configured to display, in response to a multimedia item selected by a user in a graphical user interface, a bidding parameter input interface.

The bidding task processing module 1302 can be configured to generate, based on a current bidding parameter corresponding to the multimedia item input by the user in the bidding parameter input interface, a bidding task, and send the bidding task to the server.

According to an exemplary embodiment of the present disclosure, the apparatus 130 further includes a virtual resource authentication processing module.

The virtual resource authentication processing module can be configured to trigger, after inputting the current bidding parameter corresponding to the multimedia item by the user, a virtual resource authentication process for the user, so as to generate, after determining that the user has completed the virtual resource authentication process, the bidding task based on the current bidding parameter.

According to an exemplary embodiment of the present disclosure, the apparatus 130 further includes a bidding parameter compliance processing module.

The bidding parameter compliance processing module can be configured to determine, after inputting the current bidding parameter corresponding to the multimedia item by the user, whether the current bidding parameter conforms a predetermined bidding rule, so as to generate, upon determining that the current bidding parameter conforms the bidding rule, the bidding task.

According to an exemplary embodiment of the present disclosure, the apparatus 130 further includes a task feedback message processing module.

The task feedback message processing module can be configured to receive a bidding task feedback message corresponding to the bidding task, where the bidding task feedback message includes a successful or unsuccessful bid.

According to an exemplary embodiment of the present disclosure, the apparatus 130 further includes a virtual resource processing module.

The virtual resource processing module can be configured to receive task status change information corresponding to the multimedia item; and trigger a user virtual resource processing task process corresponding to the multimedia item.

According to an exemplary embodiment of the present disclosure, the apparatus 130 further includes an identity information authentication module.

The identity information authentication module can be configured to trigger an authentication process for identity information of the user when the user inputs the current bidding parameter corresponding to the multimedia item in the bidding parameter input interface.

According to an exemplary embodiment of the present disclosure, the apparatus 130 further includes an attribution information displaying module.

The attribution information displaying module can be configured to configure multimedia data attribution information corresponding to the multimedia item based on the user information of the user.

According to an exemplary embodiment of the present disclosure, the apparatus 130 further includes an attribution information display controlling module.

The attribution information display controlling module can be configured to determine a mode of display for the multimedia data attribution information corresponding to the multimedia item based on display configuration information for the multimedia data attribution information of the user.

According to an exemplary embodiment of the present disclosure, the apparatus 130 further includes a revenue data processing module.

The revenue data processing module can be configured to display a list of multimedia items in the graphical user interface, where the list of multimedia items includes a plurality of categories based on the status of the multimedia items; and to display, in response to a selection operation of the multimedia items of the target category in the list of multimedia items, revenue information corresponding to the multimedia items based on received revenue data.

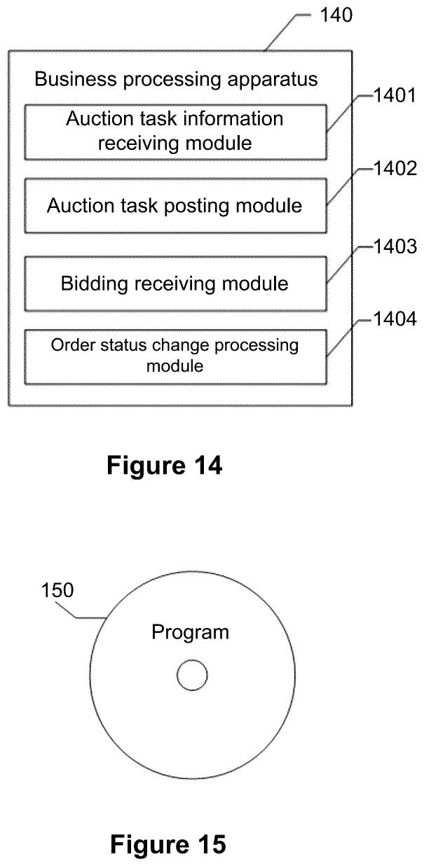

Referring to FIG. 14, a business processing apparatus applied to a server according to an exemplary embodiment of the present disclosure is described.

Referring to FIG. 14, the business processing apparatus 140 according to an exemplary embodiment of the present disclosure may include an auction task information receiving module 1401, an auction task posting module 1402, a bidding task receiving module 1403, and an order status change processing module 1404.

The auction task information receiving module 1401 can be configured to receive auction task information uploaded by a first user, wherein the auction task information includes item information and business data corresponding to a multimedia item.

The auction task posting module 1402 can be configured to establish, based on the auction task information, an auction task, and post the auction task.

The bidding task receiving module 1403 can be configured to receive a bidding task uploaded by a second user, wherein the bidding task includes the item information and a current bidding parameter corresponding to the multimedia item.

The order status change processing module 1404 can be configured to generate, based on the bidding task, order status change information corresponding to the multimedia item, and send the order status change information to the first user.

According to an exemplary embodiment of the present disclosure, the apparatus 140 further includes a review task activating module.

The review task activating module can be configured to trigger a task review process based on the auction task information to obtain a task review result; and trigger the auction task establishing process when the task review result indicates a pass.

According to an exemplary embodiment of the present disclosure, the apparatus 140 further includes an item attribution determining module.

The item attribution determining module can be configured to determine, upon reaching a predetermined execution time corresponding to the auction task, a task status change information corresponding to the multimedia item based on the bidding task corresponding to the earliest time and highest value, and to send task status change information to the first user and the second user.

According to an exemplary embodiment of the present disclosure, the apparatus 140 further includes an attribution information displaying module.

The attribution information displaying module can be configured to configure multimedia data attribution information corresponding to a multimedia item based on the user information of the second user.

According to an exemplary embodiment of the present disclosure, the apparatus 140 further includes an attribution information display configuring module.

The attribution information display configuring module can be configured to determine a mode of display for the multimedia data attribution information corresponding to the multimedia item based on display configuration information for the multimedia data attribution information by the second user.

According to an exemplary embodiment of the present disclosure, the business data configured for the multimedia item includes an authorization period parameter, an authorization ratio parameter, and an initial price parameter.

According to an exemplary embodiment of the present disclosure, the apparatus 140 further includes a revenue information processing module.

The revenue information processing module can be configured to aggregate item asset revenue information corresponding to the multimedia item according to a predetermined statistical cycle; determine, in combination with the authorization ratio parameter and the item asset revenue information, first user revenue information corresponding to the first user and second user revenue information corresponding to the second user; and send the first user revenue information to the first user and send the second user revenue information to the second user.

Since the various functional modules of the business processing apparatuses of embodiments of the present disclosure are the same as the above-mentioned embodiments of the business processing methods, they are not repeated here.

### Exemplary Storage Medium

After the business processing methods and apparatuses of the exemplary embodiments of the present disclosure has been introduced, a storage medium of exemplary embodiments of the present disclosure is illustrated with reference to FIG. 15.

Referring to FIG. 15, a program product 150 for implementing the foregoing methods according to an embodiment of the present disclosure is described. The program product may be a portable compact disk read-only memory (CD-ROM), including a program code, and may be run on a device such as a personal computer. However, the program product of the present disclosure is not limited thereto. In this document, the readable storage medium may be any tangible medium including or storing a program, and the program may be used by or in combination with an instruction execution system, apparatus, or device.

The program product may use any combination of one or more readable media. The readable medium may be a readable signal medium or a readable storage medium. The readable storage media may be, for example but is not limited to, electrical, magnetic, optical, electromagnetic, infrared, or semiconductor systems, apparatuses or devices, or any combination thereof. More specific examples (a non-exhaustive list) of the readable storage medium include: an electrical connection with one or more wires, a portable disk, a hard disk, a random-access memory (RAM), a read-only memory (ROM), an erasable programmable read-only memory (EPROM or a flash memory), an optical fiber, a portable compact disk read-only memory (CD-ROM), an optical memory device, a magnetic storage device, or any appropriate combination thereof.

The computer readable signal medium may be a data signal included in a baseband or transmitted as a part of a carrier, which carries a readable program code. This propagated data signal can take many forms, including but not limited to electromagnetic signals, optical signals, or any suitable combination thereof. The readable signal medium may alternatively be any readable medium other than a readable storage medium, and the readable signal medium may be used to send, propagate, or transmit a program used by or in combination with an instruction execution system, apparatus, or device.

The program code included in the readable signal medium may be transmitted by using any suitable medium, including but not limited to a wireless medium, a wired medium, an optical cable, RF, or any appropriate combination thereof.

A program code for performing the operation of the present disclosure may be written by using one or any combination of more programming languages. The programming language includes an object-oriented programming language such as Java, C++, and a conventional procedural programming language such as a “C” Language or a similar programming language. The program code may be fully executed on a computing device of a user, or may be partially executed on a computing device of a user and partially executed on a remote computing device, or may be fully executed on a remote computing device or a server. In case of the remote computing device, the remote computing device may be connected to the computing device of a user by using any network including a local area network (LAN) or a wide area network (WAN), or may be connected to an external computing device (for example, connected to the external computing device through the Internet by using an Internet service provider).

### Exemplary Electronic Device

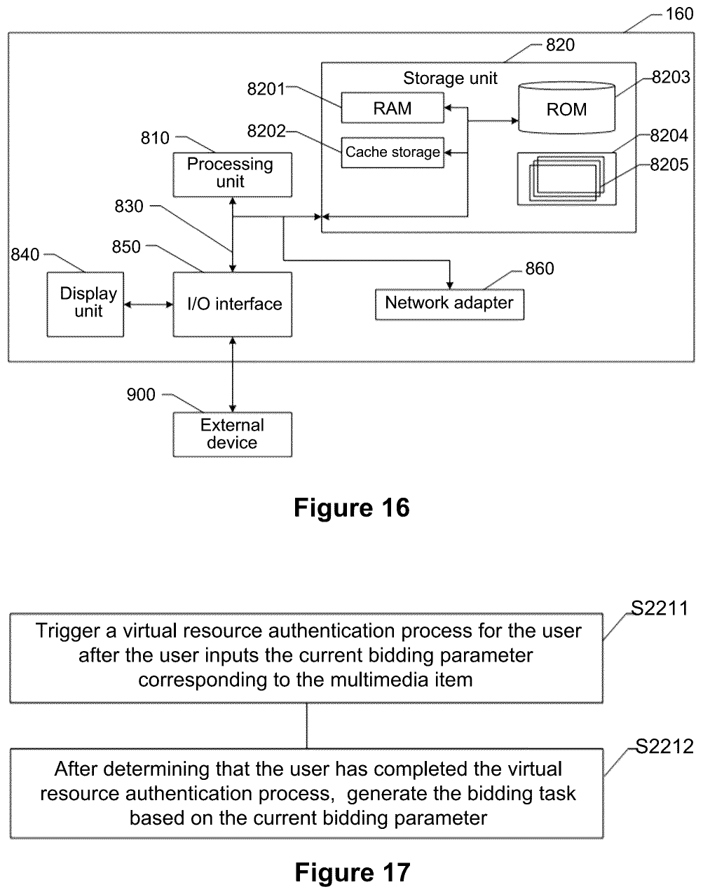

After the storage media of the exemplary embodiments of the present disclosure has been introduced, an electronic device of exemplary embodiments of the present disclosure is illustrated with reference to FIG. 16.

The electronic device 160 shown in FIG. 16 is merely an example, and should not constitute any limitation on the functions and range of use of the embodiments of the present disclosure.

As shown in FIG. 16, the electronic device 160 is represented in a form of a general computing device. Components of the electronic device 160 may include, but are not limited to: the at least one processing unit 810, the at least one storage unit 820, a bus 830 connecting different system components (including the storage unit 820 and the processing unit 810), and a display unit 840.

The storage unit stores program codes being executable by said processing unit 810, so that the processing unit 810 performs steps according to the various exemplary embodiments of the present disclosure described in the foregoing part of “the exemplary method” of the specification. For example, the processing unit 810 may perform the steps as shown in FIG. 1, or the steps as shown in FIG. 5, or the steps shown in FIG. 10.

The storage unit 820 may include a volatile storage unit, such as a random access memory (RAM) 8201 and/or a cache storage unit 8202, and may further include a read-only memory (ROM) 8203.

The storage unit 820 may further include a program/utility tool 8204 having a set of (at least one) program modules 8205. Such a program module 8205 includes but is not limited to: an operating system, one or more application programs, other program modules, and program data, and each or a combination of these examples may include implementation of a network environment.

A bus 830 may include a data bus, an address bus, and a control bus.

The electronic device 160 may also communicate with one or more external devices 900 (e.g., keyboard, pointing device, Bluetooth device, etc.), and the communication may be achieved through the input/output (I/O) interface 850. The electronic device 160 also includes a display unit 840, which is connected to the input/output (I/O) interface 850 for display. In addition, the electronic device 160 may further communicate with one or more networks (such as a local area network (LAN), a wide area network (WAN), and/or a public network, for example, the Internet) by using a network adapter 860. As shown in the figure, the network adapter 860 communicates with other devices of the electronic device 160 by using the bus 830. It should be understood that although not shown in the figure, other hardware and/or software modules may be used in combination with the electronic device 160, including but not limited to: microcode, a device driver, a redundant processing unit, an external disk drive array, a RAID system, a tape driver, a data backup storage system, and the like.

It should be noted that although several modules or sub-modules of the business processing apparatuses are mentioned in the foregoing detailed description, such division is only exemplary and not mandatory. In practice, according to the implementations of the present disclosure, the features and functions of two or more units/modules described above may be embodied in one unit/module. Conversely, the features or functions of one unit/module described above may further be divided and embodied by a plurality of units/modules.

Furthermore, although the operations of the methods of the present disclosure are described in a specific order in the drawings, this does not require or imply that these operations must be performed in the specific order, or that all of the operations shown must be performed to achieve the expected results. Additionally, or alternatively, certain steps may be omitted, a plurality of steps may be combined into one step for execution, and/or one step may be split into a plurality of steps for execution.

### Auctioning on a Cloud-Based Media Content Management Platform

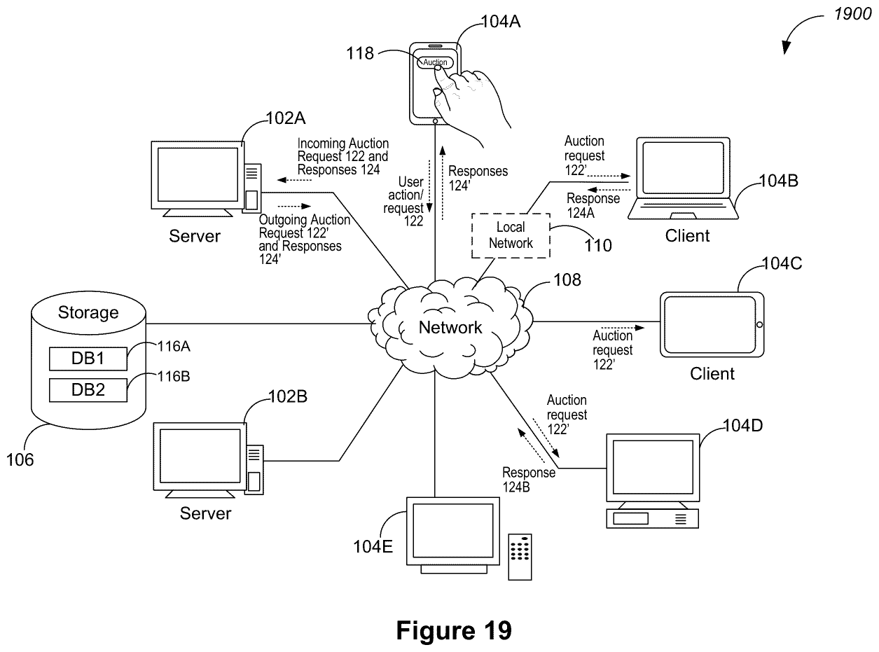

FIG. 19 is an example media content management environment 1900 having one or more servers 102 communicatively coupled to one or more media devices 104, in accordance with some embodiments. The one or more media devices 104 (e.g., cell phone 112 in FIG. 11) are configured to control play of media content, and may be, for example, mobile phones 104A, laptop computers 104B, tablet computers 104C, desktop computers 104D, and smart television devices 104E. Each media device 104 can collect data or user inputs, executes media applications, present outputs on a user interface, or play media content. Examples of the media applications include, but are not limited to, media play applications, media control applications, and media management applications. The collected data or user inputs can be processed locally at the media device 104 and/or remotely by the server(s) 102. The one or more servers 102 (e.g., server 113 in FIG. 11) provide system data (e.g., boot files, operating system images, and user applications) to the media devices 104, and in some embodiments, processes the data and user inputs received from the media device(s) 104 when the media applications are executed on the media devices 104. In some embodiments, the data processing environment 100 further includes a storage 106 for storing data related to the servers 102, media devices 104, and media applications executed on the media devices 104.

The one or more servers 102 are configured to enable real-time data communication with the media devices 104 that are remote from each other or from the one or more servers 102. In some embodiments, the one or more servers 102 are communicatively coupled to millions of media devices 104 and configured to process auction or bidding requests from the millions of media devices 104 concurrently. For example, a server 102 hosts a media content management platform corresponding to a media play application. Media auctioning is added as an additional function to the media play application, which has long existed to allow a user to obtain and play media content. In some embodiments, a media device 104A issues an auction request 122 to a server 102 to initiate an auction, and the server 102 communicates an auction request 122′ to a large number of media devices 104 (e.g., media devices 104B-104D) distributed across different geographic locations. The server 102 allows the large number of media devices 104 to respond to the auction request with bidding requests 124 within a duration of time while monitoring a status of a corresponding auction in real time (i.e., with no or little latency). Under some circumstances, more than media devices 104 are involved in the auction, and such a large-scale auction is nearly impossible to manage entirely as human activities and without using the media content management platform. Additionally, in some embodiments, the server 102 can manage different types of auction data (e.g., ownership data, media information, auction parameters) with different security levels, thereby enabling a real-time, efficient, and secure auction that is hard to accomplish in real life by human only.

The one or more servers 102, one or more media devices 104, and storage 106 are communicatively coupled to each other via one or more communication networks 108, which are the medium used to provide communications links between these devices and computers connected together within the media content management environment 1900. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 108 may be established either directly (e.g., using 3G/4G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, a content management method is implemented to facilitate an auction at a server system 102 (e.g., including one or more servers 102) that hosts a media content management platform. A server system 102 executes a media play application on the media content management platform, which is accessible to the plurality of user accounts. The server system 102 enables display of a first user interface in the media play application for a first user account, which is optionally associated with a first media device 104A and a first user. The first user interface includes an information item identifying a media content item (e.g., a song, a video clip, an article, a book) and a user-selectable affordance item associated with the media content item. The server system 102 receives, from the first user account, a user action 122 (i.e., a user request 122 for auction) on the user-selectable affordance item to initiate the auction of interest of the media content item owned by the first user account. In response to the user action, an auction request 122′ of the media content item is generated and distributed for the first user account. The server system 102 receives a response 124A (i.e., a bidding request 124A) to the auction request 122′ from a second user account, and associates the media content item with the second user account. The second user account is optionally associated with a second media device 104B and a second user. It is noted that in some embodiments, the interest of the media content item to be auctioned is the interest created by play of the media content item on the media play application.

In some embodiments, in response to the user action 122, the server system 102 confirms that the first user account is entitled to receiving the interest of the media content item, and verifies the second user account. In accordance with a verification of the second user account, the server system 102 associates the media content item with the second user account. Further, in some embodiments, the server system 102 is communicatively coupled to a plurality of electronic devices 104 associated with the plurality of user accounts. The server system 102 hosts, e.g., in the storage 106, a user account database 116A having a first security level and a content title database 116B having a second security level higher than the first security level. In response to the user action, in accordance with the second security level, the server system 102 searches the content title database 116B to identify a chain of title of the media content item. Based on the chain of title, the first user account is confirmed to be entitled to receiving the interest of the media content item, and the auction request 122′ of the media content item is generated in accordance with a confirmation that the first user account is entitled to receiving the interest of the media content item. The user account database 116A is accessed with the first security level to verify the second user account. Additionally, in some embodiments, the content title database 116B is stored in a dedicated server computer that requires additional encryption protection compared with a distinct server computer for storing the user account database 116A.

In some embodiments, referring to FIG. 2, the server system 102 enables displaying a second user interface 200 on the first media device 104A to receive a plurality of user-defined auction parameters, the auction request including the plurality of user-defined auction parameters (e.g., song title). The media content item is associated with the second user account based on the plurality of user-defined auction parameters. Further, in some embodiments, the plurality of user-defined auction parameters include one or more of: a temporal length of the interest (i.e., “authorization period” in FIG. 2), a percentage of an entire interest (i.e., “authorization ratio” in FIG. 2), a starting price, a deposit, an auction period, and an auction agreement. For example, the first user associated with the first user account selects the song title of the media content item in a drop-down menu and defines the authorization period to be “5 years” on the second user interface 200. The authorization ratio is predefined as 90%. When the second user associated with the second user account wins the auction, the second user account is associated with the media content item identified by the song title as sharing 90% of the interest of the media content item for the next five years.

Specifically, in some embodiments, the media content item is associated with the second user account by defining an interest information item including the plurality of user-defined auction parameters and an identification of the second user account, encrypting the interest information item based on a second security level (also called an enhanced security level), and storing the encrypted interest information item with a chain of title of the media content item in a content title database having the second security level. Stated another way, the chain of title of the media content items includes secure ownership information, and is stored with the enhanced security level using encryption.

In some embodiments, referring to FIG. 6, after the second user account wins the auction, a message is sent to the second user account and displayed on a user interface 600 notifying the second user account of winning the auction. The server system 102 associates the media content item with the second user account by enabling display of the user interface 600 notifying the second user associated with the second user account of winning the auction.

Additionally, in some embodiments, the first user associated with the first user account is allowed to modify the auction parameters while the auction is going on. In accordance with a determination that a current time is within an auction period of the auction request, the server system 102 receives from the first user account user inputs modifying a subset of the plurality of user-defined auction parameters, and updating the auction request 122′ of the media content item for the first user account.

In some embodiments, the media content item is associated with the second user account by storing an identification of the second user account with the media content item in a user account database 116A having a first security level (also called an average security level). Further, in some embodiments, referring to FIG. 7, for one of the plurality of user accounts, the media device 104 associated the one of the plurality of user accounts displays a third user interface 700 in the media play application. The third user interface 700 includes the information item identifying the media content item, the identification of the second user account, and one or more of: play control affordance items, singer name, composer name, and album name. After the auction is completed, information of the second user account is displayed with the media content item to indicate the association with the media content item to the one of the plurality of user accounts controlling play of the media content item, and the one of the plurality of user accounts is optionally the first user account, the second user account, or a third distinct user account.

In some embodiments, in accordance with a determination that a current time is within an auction period of the auction request, in response to a user request from the first user account, the server system 102 enables displaying a fourth user interface 800 including a plurality of auction responses to the auction request on the first media device 104A associated with the first user account, thereby indicating progress of the auction of the media content item for the first user account. Referring to FIG. 3, in some embodiments, the first user manages a plurality auctions of media content items. An auction management page is displayed to monitor lists for “to-be-listed auction,” “auction not started,” “auction in progress,” “ended auction.” In response to selection of a media content item in a list of “auction in progress,” the server system 100 displays the fourth user interface 800 on the fir media device 104A to monitor a status of a particular auction.

In some embodiments, in response to the response to the auction request 122′, the server system 102 enables displaying another fourth user interface 800 including information of a plurality of auction responses to the auction request 122′ on the media device 104B associated with the second user account, thereby indicating progress of the auction of the media content items for the second user account.

In some embodiments, the first user account is associated with a production company that represents an original creator of the media content item or a user of the media play application who directly or indirectly obtained part or all of the interest of the media content item from the production company, and the chain of title is started with the production company and ended with the first user account.

In some embodiments, the first user interface of the media play application further includes a plurality of media play control affordance items configured to receive user commands for controlling play of the media content item.

In some embodiments, the media content item including a first media content item, wherein the first user interface includes a list of media content items including the first media content item, and the user action selects the first media content item in the list for auction.

In some embodiments, the second user account is only one of a set of user accounts submitting bidding requests in response to the auction request. That said, in response to the auction request 122′, the server system 102 receives a plurality of auction responses 124 (e.g., 124A and 124B) including the response 124A from the second user account. The first user associated with the first user account reviews the plurality of auction responses 124, and the server system 102 receives, from the first user account, a user selection of the response 124A from the second user account. The second user account is identified as a winner of the auction.

In some embodiments, in response to the auction request, the server system 102 receives a plurality of auction responses 124 including the response 124A from the second user account. In accordance with a determination that the response from the second user account satisfies a predefined auction winning criterion, the server system 102 automatically selecting the response 124A from the plurality of auction responses 124 on behalf of the first user account. Further, in some embodiments, in accordance with the predefined auction winning criterion, the response 124A from the second user account includes a bidding price that is the highest among the plurality of auction responses. In some embodiments, in accordance with the predefined auction winning criterion, the second user account has a deposit that is greater than a predefined monetary value.

In some embodiments, an interest of the media content item to be auctioned is a predefined portion (e.g., 90%) of an entire interest of the media content item. The predefined portion is less than the entire interest, and the second user account acquires the predefined portion of the entire interest of the media content item from the first user account, thereby sharing the interest of the media content item with a production company that represents an original creator of the media content item. For example, the predefined portion is 90%. The original creator of the media content item retains 10% of the entire interest of the media content item generated by the media play application, while the remaining 90% of the interest of the media content item is distributed to an auction winner.

In some embodiments, during a duration of time, the server system 102 accumulatively tracks play of the media content item by the plurality of user accounts on the media content management platform, and determines revenue associated with the play of the media content item. Referring to FIG. 8, in some embodiments, the server system 102 enables display of a fifth user interface 800 for tracking the revenues for the second user account that is associated with one or media content items including the media content item. At an end of the duration of time, the server system 102 automatically distributes the revenue based on a chain of title to at least one of a production company that represents an original creator of the media content item, the first user account, and the second user account. For example, the revenue is distributed at the end of each month.

In some embodiments, this application is directed to a computer system (e.g., a server system 102) that hosts a media content management platform accessible to a plurality of user accounts of a media play application. The computer system includes one or more processors and memory for storing one or more programs. The one or more programs include instructions for performing the method described above.

In some embodiments, this application is directed to a non-transitory computer-readable storage medium storing one or more programs configured for hosting a media content management platform accessible to a plurality of user accounts of a media play application. The one or more programs include instructions for performing the content management method implemented by a computer system (e.g., a server 102) as described above.

In another aspect, a media content management method is implemented at a server 102. The server 102 receives auction task information from a first user account. The he auction task information includes item information and business data corresponding to a media content item. Based on the auction task information, the server 102 establishes an auction task, e.g., by sending an auction request 122′. The auction task is distributed to a plurality of user accounts. In response to the auction task, the server 102 receives a first bidding task (e.g., a response or bidding request 124A) from a second user account. The first bidding task includes the item information and a current bidding parameter corresponding to the media content item. Based on the first bidding task, the server generates order status change information corresponding to the media content item and sends the order status change information to the first user account.

In some embodiments, before establishing the auction task based on the auction task information, the server 102 enables a task review process based on the auction task information to obtain a task review result, and enables the auction task establishing process when the task review result indicates a pass.

In some embodiments, the server 102 determines, upon reaching a predetermined execution time corresponding to the auction task, a task status change information corresponding to the media content item based on the first bidding task corresponding to the earliest time and highest value, and sends task status change information to the first user account and the second user account.

In some embodiments, the server 102 configures media content data attribution information corresponding to a media content item based on the user information of the second user account. Further, in some embodiments, the server 102 determines a mode of display for the media content data attribution information corresponding to the media content item based on display configuration information for the media content data attribution information by the second user account.

In some embodiments, the business data configured for the media content item includes an authorization period parameter, an authorization ratio parameter, and an initial price parameter. Further, in some embodiments, the server 102 aggregates item asset revenue information corresponding to the media content item according to a predetermined statistical cycle; determines, in combination with the authorization ratio parameter and the item asset revenue information, first user revenue information corresponding to the first user account and second user revenue information corresponding to the second user account; sends the first user revenue information to the first user account; and sends the second user revenue information to the second user account.

In some embodiments, the server 102 hosts a database 116 (e.g., 116A and 116B) storing user information and media information. The server 102 is communicatively coupled to electronic devices (e.g., media devices 104) associated with the first and second user accounts. The server 102 searches the database to identify a chain of title of the media content item. Based on the chain of title, the server 102 confirms that the first user account is entitled to receiving an interest of the media content item. Further, in some embodiments, the server 102 accesses the database to verify the second user account. In accordance with a verification of the second user account, the media content item is associated with the second user account to generate and store, in the database, the order status change information.

In some embodiments, the auction task information including a plurality of user-defined auction parameters. Referring to FIG. 2, the server 102 enables display of a user interface 200 to the first user account. The user interface 200 is configured to receive the plurality of user-defined auction parameters of the auction task information. The plurality of user-defined auction parameters include one or more of: a temporal length of an interest, a percentage of an entire interest, a starting price, a deposit, an auction period, and an auction agreement. Further, in some embodiments, in accordance with a determination that a current time is within the auction period of the auction task, the server 102 receives from the first user account user inputs modifying a subset of the plurality of user-defined auction parameters, and updates the auction request of the media content item for the first user account.

In some embodiments, referring to FIG. 6, after the second user account wins the auction, a message is sent to the second user account and displayed on a user interface 600 notifying the second user account of winning the auction. In some embodiments, referring to FIG. 7, for one of a plurality of user accounts, after sending the order status change information, the server enable display of a user interface 700 in a media play application. The user interface includes an information item identifying the media content item, an identification of the second user account, and one or more of: play control affordance items, singer name, composer name, and album name.

In some embodiments, in accordance with a determination that a current time is within an auction period of the auction request, in response to a user request from the first user account, the server 102 enables display of a user interface including a plurality of auction responses to the auction request, thereby indicating progress of the auction of the media content items for the first user account. Conversely, in some embodiments, in response to the response to the auction request, the server 102 enables display, for the second user account, of a user interface including information of a plurality of auction responses, thereby indicating progress of the auction of the media content items for the second user account.

In some embodiments, in response to the auction task, the server 102 receives a plurality of bidding tasks including the first bidding task from a plurality of media devices 104. In accordance with a determination that the first bidding task satisfies a predefined auction winning criterion, the server 102 automatically selecting the first bidding task from the plurality of bidding tasks as a winner. Further, in some embodiments, in accordance with the predefined auction winning criterion, the second user account has a deposit that is greater than a predefined monetary value.

In some embodiments, an interest of the media content item to be auctioned is a predefined portion (e.g., 90%) of an entire interest of the media content item, the predefined portion less than the entire interest, and the second user account acquires the predefined portion of the entire interest of the media content item from the first user account.

In some embodiments, during a duration of time, the server 102 accumulatively tracks play of the media content item by the plurality of user accounts on a media content management platform hosted by the server, and determines revenue associated with the play of the media content item, e.g., upon request, periodically every 10 minutes, and according to a fixed schedule. At an end of the duration of time, the server 102 automatically distributes the revenue based on a chain of title to at least one of a production company that represents an original creator of the media content item, the first user account, and the second user account.

In some embodiments, this application is directed to a computer system (e.g., a server system 102) that hosts a media content management platform accessible to a plurality of user accounts of a media play application. The computer system includes one or more processors and memory for storing one or more programs. The one or more programs include instructions for performing the method described above.

In some embodiments, this application is directed to a non-transitory computer-readable storage medium storing one or more programs configured for hosting a media content management platform accessible to a plurality of user accounts of a media play application. The one or more programs include instructions for performing the content management method implemented by a computer system (e.g., a server 102) as described above.

In yet another aspect, a media content management method is implemented at a first media device 104A. The first media device 104A receives user inputs on a graphical user interface 200 (FIG. 2). The user inputs identify a media content item and business data associated with the media content item. In response to the user inputs, the first media device 104A establish an auction task corresponding to the media content item, and sends information of the auction task to a server 102. The information of the auction task includes a request 122 to post the auction task by the server 102. In some embodiments, after sending the auction task to the server 102, the first media device 104 receives a review result of the auction task from the server 102, and labels the auction task according to the review result. For example, the types of labels can include: pending review, timeout not reviewed, and failure to pass the review. In an example, an auction request 122 fails the review because the first user account associated with the first media device 104A has previously sold its interest of a song and is not entitled to the interest according to a chain of title of a song.

In some embodiments, the first media device receives, during the execution cycle of the auction task, order status change information corresponding to the auction task.

In some embodiments, the business data associated with the media content item includes one or more of an authorization period parameter, an authorization ratio parameter, and an initial price parameter.

In some embodiments, the first media device 104A collects playback history data corresponding to the media content item, evaluates an initial price of the media content item based on the playback history data, and presents the initial price evaluation result to a user.

In some embodiments, the first media device 104A displays a list of auction tasks in the graphical user interface, and the list of auction tasks includes a plurality of categories of tasks according to task execution status. The first media device 104A displays task information for the auction task in response to a selection operation for an auction task in the list of auction tasks.

In some embodiments, this application is directed to a computer system (e.g., a first media device 104A making an auction request 122) that hosts a media content management platform accessible to a plurality of user accounts of a media play application. The computer system includes one or more processors and memory for storing one or more programs. The one or more programs include instructions for performing the method described above.

In some embodiments, this application is directed to a non-transitory computer-readable storage medium storing one or more programs configured for hosting a media content management platform accessible to a plurality of user accounts of a media play application. The one or more programs include instructions for performing the content management method implemented by a computer system (e.g., a first media device 104A making an auction request 122) as described above.

In yet another aspect, a media content management method is implemented at a second media device 104B. In response to a user selection of a media content item on a graphical user interface, the second media device 104B displays a bidding parameter input interface and receives, on the bidding parameter input interface, a user input of a current bidding parameter (e.g., a bidding price) corresponding to the media content item. The second media device 104B generates a bidding task 124 based on the current bidding parameter, and sends information of the bidding task 124 to a server 102.

In some embodiments, after receiving the user input of the current bidding parameter corresponding to the media content item, the second media device 104B enables a virtual resource authentication process for the user, determines that the user has completed the virtual resource authentication process, and generates the bidding task 124 based on the current bidding parameter.

In some embodiments, after receiving the user input of the current bidding parameter corresponding to the media content item, the second media device 104B determines whether the current bidding parameter conforms a predetermined bidding rule and generates the bidding task 124 upon determining that the current bidding parameter conforms the bidding rule. For example, the auction request 122′ received by the second user account includes a minimum bidding price. The second media device 104B determines whether a bidding price in the current bidding parameter is greater than the minimum bidding price. In accordance with a determination that the bidding price in the current bidding parameter is greater than the minimum bidding price, the second media device 104B generates the bidding task 124. In accordance with a determination that the bidding price in the current bidding parameter is not greater than the minimum bidding price, the second media device 104B aborts generation of the bidding task 124.

In some embodiments, the second media device 104B receives a bidding task feedback message corresponding to the bidding task, e.g., from the server 102. The bidding task feedback message includes a successful or unsuccessful bid.

In some embodiments, the second media device 104B receives task status change information corresponding to the media content item, e.g., from the server 102, and enables a user virtual resource processing task process corresponding to the media content item.

In some embodiments, the second media device 104B enables an authentication process for verifying identity information of the second user associated with the second user account when the second user inputs the current bidding parameter corresponding to the media content item in the bidding parameter input interface.

In some embodiments, the second media device 104B configures multimedia data attribution information corresponding to the media content item based on the user information of the second user.

Additionally, in some embodiments, the second media device 104B determines a mode of display for the multimedia data attribution information corresponding to the media content item based on display configuration information for the multimedia data attribution information of the user.

In some embodiments, the second media device 104B displays a list of media content items in the graphical user interface. The list of media content items includes a plurality of categories based on the status of the media content items. In response to a selection operation of the media content items of the target category in the list of media content items, the second media device 104B displays revenue information corresponding to the media content items based on received revenue data.

In some embodiments, this application is directed to a computer system (e.g., a second media device 104B making a bidding request 124) that hosts a media content management platform accessible to a plurality of user accounts of a media play application.

The computer system includes one or more processors and memory for storing one or more programs. The one or more programs include instructions for performing the method described above.

In some embodiments, this application is directed to a non-transitory computer-readable storage medium storing one or more programs configured for hosting a media content management platform accessible to a plurality of user accounts of a media play application. The one or more programs include instructions for performing the content management method implemented by a computer system (e.g., a second media device 104B making a bidding request 124).

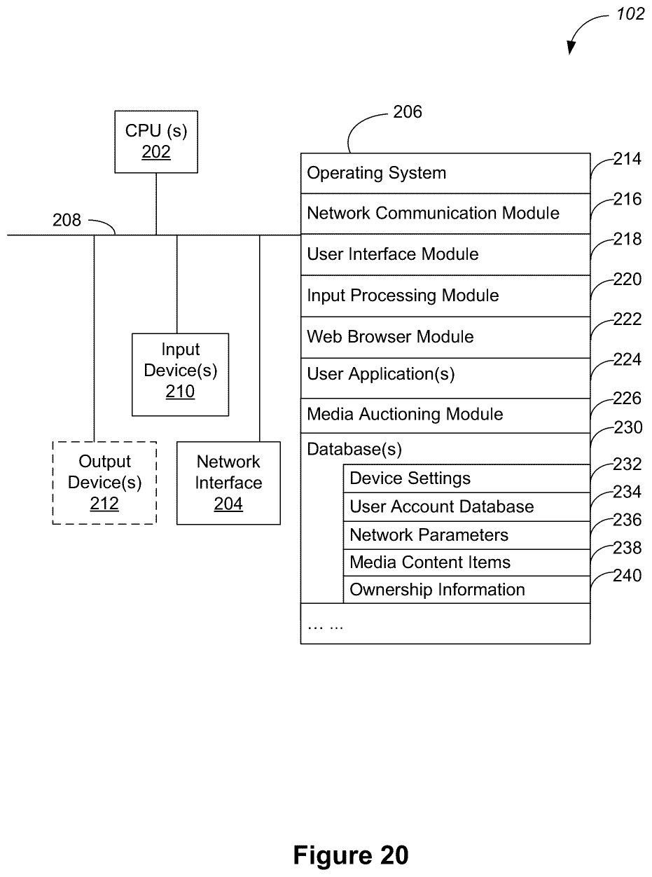

Any content management method described above is, optionally, governed by instructions that are stored in a non-transitory computer readable storage medium and that are executed by one or more processors of a server 102 or a media device 104. Each of the operations may correspond to instructions stored in a computer memory or non-transitory computer readable storage medium (e.g., memory 2006 of the server 102 in FIG. 20). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in any content management method may be combined and/or the order of some operations may be changed.

It should be understood that the particular order in which the operations in a content management method have been described are merely exemplary and are not intended to indicate that the described order is the only order in which the operations could be performed. One of ordinary skill in the art would recognize various ways to generate a content management method as described herein. Additionally, it should be noted that details of any content management process described above for one aspect of this application are also applicable in an analogous manner to other content management processes described for other aspects and related embodiments of this application. For brevity, these details are not repeated here.

While the spirit and principles of the present disclosure have been described with reference to several specific embodiments, it should be understood that the present disclosure is not limited to the specific embodiments disclosed, nor does the division of aspects imply that features in those aspects cannot be combined for benefit; such division is for convenience of presentation only. The present disclosure is intended to cover various modifications and equivalent arrangements included within the spirit and scope of the appended claims.

FIG. 20 is a block diagram illustrating a server 102, in accordance with some embodiments. The server 102 is configured to implement some of the implementations of the content management methods described above. The server 102, typically, includes one or more processing units (CPUs) 202, one or more network interfaces 204, memory 206, and one or more communication buses 208 for interconnecting these components (sometimes called a chipset). The server 102 includes one or more input devices 210 that facilitate user input, such as a keyboard and a mouse. Furthermore, in some embodiments, the media device 104 of the server 102 uses a The server 102 also includes one or more output devices 212 that enable presentation of user interfaces and play media content items, including one or more speakers and/or one or more visual displays. Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 202. Memory 206, or alternatively the non-volatile memory within memory 206, includes a non-transitory computer readable storage medium. In some embodiments, memory 206, or the non-transitory computer readable storage medium of memory 206, stores the following programs, modules, and data structures, or a subset or superset thereof:
Operating system 214 including procedures for handling various basic system services and for performing hardware dependent tasks;
Network communication module 216 for connecting each server 102 to other devices (e.g., server 102, media device 104, or storage 106) via one or more network interfaces 204 (wired or wireless) and one or more communication networks 108, such as the Internet, other wide area networks, local area networks, metropolitan area networks, and so on;
User interface module 218 for enabling presentation of information (e.g., a graphical user interface for application(s) 224, widgets, websites and web pages thereof, and/or games, audio and/or video content, text, etc.) at each media device 104 via one or more output devices 212 (e.g., displays, speakers, etc.);
Input processing module 220 for detecting one or more user inputs or interactions from one of the one or more input devices 210 and interpreting the detected input or interaction;
Web browser module 222 for navigating, requesting (e.g., via HTTP), and displaying websites and web pages thereof, including a web interface for logging into a user account associated with a media device 104 or another electronic device, controlling the client or electronic device if associated with the user account, and editing and reviewing settings and data that are associated with the user account;
One or more user applications 224 for execution by the server 102 (e.g., a media play application);
Media auctioning module 226 for managing auctioning of media content items among a plurality of user accounts and distributing interest of media content items based on a chain of title that varies with auctioning of the media content items;
One or more databases 230 for storing at least data including one or more of:
   Device settings 232 including common device settings (e.g., service tier, device model, storage capacity, processing capabilities, communication capabilities, etc.) of the one or more servers 102 or media devices 104;
   User account information 234, which is stored in a user account database 116A (FIG. 19) for the one or more user applications 224, e.g., user names, security questions, account history data, user preferences, and predefined account settings;
   Network parameters 236 for the one or more communication networks 108, e.g., IP address, subnet mask, default gateway, DNS server and host name;
   Media content items 238; and
   Ownership information 240, of the media content items 236, which is stored in a content title database 116B (FIG. 19).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 206, optionally, stores a subset of the modules and data structures identified above. Furthermore, memory 206, optionally, stores additional modules and data structures not described above.

It is noted that each of the media devices 104 has a similar block diagram shown in FIG. 19. For brevity, the block diagrams of the media devices 104 are not repeated here.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A media content management method implemented at a server, comprising:
receiving auction task information from a first user account, wherein the auction task information includes item information and business data corresponding to a media content item;
establishing, based on the auction task information, an auction task;
distributing the auction task to a plurality of user accounts;
receiving a first bidding task from a second user account, wherein the first bidding task includes the item information and a current bidding parameter corresponding to the media content item;
generating, based on the first bidding task, order status change information corresponding to the media content item; and
sending the order status change information to the first user account.

2. The method of claim 1, further comprising, before establishing, based on the auction task information, the auction task:
triggering a task review process based on the auction task information to obtain a task review result; and
triggering the auction task establishing process when the task review result indicates a pass.

3. The method of claim 1, further comprising:
determining, upon reaching a predetermined execution time corresponding to the auction task, a task status change information corresponding to the media content item based on the first bidding task corresponding to the earliest time and highest value; and
sending task status change information to the first user account and the second user account.

4. The method of claim 1, further comprising:
configuring media content data attribution information corresponding to a media content item based on the user information of the second user account.

5. The method of claim 4, further comprising:
determining a mode of display for the media content data attribution information corresponding to the media content item based on display configuration information for the media content data attribution information by the second user account.

6. The method of claim 1, wherein, the business data configured for the media content item includes an authorization period parameter, an authorization ratio parameter, and an initial price parameter.

7. The method of claim 6, further comprising:
aggregating item asset revenue information corresponding to the media content item according to a predetermined statistical cycle;
determining, in combination with the authorization ratio parameter and the item asset revenue information, first user revenue information corresponding to the first user account and second user revenue information corresponding to the second user account;
sending the first user revenue information to the first user account; and
sending the second user revenue information to the second user account.

8. The method of claim 1, wherein the server hosts a database storing user information and media information, the method further comprising:
communicatively coupling the server to electronic devices associated with the first and second user accounts;
searching the database to identify a chain of title of the media content item; and
based on the chain of title, confirming that the first user account is entitled to receiving an interest of the media content item.

9. The method of claim 8, further comprising:
accessing the database to verify the second user account; and
in accordance with a verification of the second user account, associating the media content item with the second user account to generate and store, in the database, the order status change information.

10. The method of claim 1, the auction task information including a plurality of user-defined auction parameters, further comprising:
enabling display of a user interface to the first user account, the user interface configured to receive the plurality of user-defined auction parameters of the auction task information, wherein the plurality of user-defined auction parameters include one or more of:
a temporal length of an interest, a percentage of an entire interest, a starting price, a deposit, an auction period, and an auction agreement.

11. The method of claim 10, further comprising:
in accordance with a determination that a current time is within the auction period of the auction task, receiving from the first user account user inputs modifying a subset of the plurality of user-defined auction parameters, and updating the auction request of the media content item for the first user account.

12. The method of claim 1, further comprising, for one of a plurality of user accounts:
after sending the order status change information, enable display of a user interface in a media play application, the user interface including an information item identifying the media content item, an identification of the second user account, and one or more of: play control affordance items, singer name, composer name, and album name.

13. The method of claim 1, further comprising:
in accordance with a determination that a current time is within an auction period of the auction request, in response to a user request from the first user account, enabling display of a user interface including a plurality of auction responses to the auction request, thereby indicating progress of the auction of the media content items for the first user account.

14. The method of claim 1, further comprising:
in response to the response to the auction request, enabling display, for the second user account, a user interface including information of a plurality of auction responses, thereby indicating progress of the auction of the media content items for the second user account.

15. The method of claim 1, further comprising, in response to the auction task:
receiving a plurality of bidding tasks including the first bidding task; and
in accordance with a determination that the first bidding task satisfies a predefined auction winning criterion, automatically selecting the first bidding task from the plurality of bidding tasks as a winner.

16. The method of claim 15, wherein in accordance with the predefined auction winning criterion, the second user account has a deposit that is greater than a predefined monetary value.

17. The method of claim 1, wherein an interest of the media content item to be auctioned is a predefined portion of an entire interest of the media content item, the predefined portion less than the entire interest, and the second user account acquires the predefined portion of the entire interest of the media content item from the first user account.

18. The method of claim 1, further comprising, at the server:
during a duration of time, accumulatively, tracking play of the media content item by the plurality of user accounts on a media content management platform hosted by the server, and determining revenue associated with the play of the media content item; and
at an end of the duration of time, automatically distributing the revenue based on a chain of title to at least one of a production company that represents an original creator of the media content item, the first user account, and the second user account.

19. A computer system that hosts a media content management platform accessible to a plurality of user accounts of a media play application, comprising:
one or more processors;
memory for storing one or more programs, the one or more programs comprising instructions for:
receiving auction task information from a first user account, wherein the auction task information includes item information and business data corresponding to a media content item;
establishing, based on the auction task information, an auction task;
distributing the auction task to a plurality of user accounts;
receiving a first bidding task from a second user account, wherein the first bidding task includes the item information and a current bidding parameter corresponding to the media content item;
generating, based on the first bidding task, order status change information corresponding to the media content item; and
sending the order status change information to the first user account.

20. A non-transitory computer-readable storage medium storing one or more programs configured for hosting a media content management platform accessible to a plurality of user accounts of a media play application, the one or more programs comprising instructions for:
receiving auction task information from a first user account, wherein the auction task information includes item information and business data corresponding to a media content item;
establishing, based on the auction task information, an auction task;
distributing the auction task to a plurality of user accounts;
receiving a first bidding task from a second user account, wherein the first bidding task includes the item information and a current bidding parameter corresponding to the media content item;
generating, based on the first bidding task, order status change information corresponding to the media content item; and
sending the order status change information to the first user account.
